(19) United States
(12) Patent Application Publication
(10) Pub. No.: US 2017/0179625 A1
(43) Pub. Date: Jun. 22, 2017

(54) ATTACHMENT TECHNIQUES FOR PRINTED CIRCUIT BOARDS

(71) Applicants: Kai Xiao, University Place, WA (US); Raul Enriquez Shibayama, Zapopan (MX); John C. Tomlin, Lacey, WA (US)

(72) Inventors: Kai Xiao, University Place, WA (US); Raul Enriquez Shibayama, Zapopan (MX); John C. Tomlin, Lacey, WA (US)

(21) Appl. No.: 14/977,555

(22) Filed: Dec. 21, 2015

(51) Int. Cl. H01R 12/70

(52) U.S. Cl. CPC H01R 12/7076

(57) ABSTRACT

Attachment techniques for printed circuit boards (PCBs) are described. According to some such techniques, an array of double-contact connectors may be used to attach first and second PCBs to each other. In various embodiments, each such double-contact connector may comprise respective first and second contact elements that establish and retain physical contact with the inner surfaces of vias in the first and second PCBs. In some embodiments, at least one of the double-contact connectors may provide electrical conductivity between a trace on the first PCB and a trace on the second PCB. In various embodiments, one of the two PCBs may comprise a main PCB, and the other may comprise a patch PCB arranged to relieve routing congestion in a region of the main PCB. Other embodiments are described and claimed.

### TECHNICAL FIELD

Embodiments herein generally relate to printed circuit boards (PCBs).

### BACKGROUND

Many types of electronic devices are implemented using PCBs. A set of conductive traces may be formed on one or more layers of a given PCB in order to electrically couple various electronic components mounted on the PCB. As the number of electronic components—and/or the complexity of such components—on a given PCB increases, the required number of conductive traces may also increase. A continual trend with respect to modern electronic devices is the use of increasingly complex and/or numerous components in conjunction with the implementation of ever-decreasing form factors. In view of this trend, the issue of routing congestion may be an important consideration with respect to modern electronic device design.

### BRIEF DESCRIPTION OF THE DRAWINGS

FIG. 1A illustrates an embodiment of a first double-contact connector.

FIG. 1B illustrates an embodiment of a second double-contact connector.

FIG. 2A illustrates an embodiment of a first connector array.

FIG. 2B illustrates an embodiment of a first assembly.

FIG. 3A illustrates an embodiment of a first PCB and an embodiment of a second PCB.

FIG. 3B illustrates an embodiment of a first intermediate process stage

FIG. 4A illustrates an embodiment of a second intermediate process stage.

FIG. 4B illustrates an embodiment of a third intermediate process stage.

FIG. 5A illustrates an embodiment of a fourth intermediate process stage.

FIG. 5B illustrates an embodiment of a fifth intermediate process stage.

FIG. 6 illustrates an embodiment of a second assembly.

FIG. 7A illustrates an embodiment of a third double-contact connector.

FIG. 7B illustrates an embodiment of a fourth double-contact connector.

FIG. 8A illustrates an embodiment of a second connector array.

FIG. 8B illustrates an embodiment of a third assembly.

FIG. 9A illustrates an embodiment of a third PCB and an embodiment of a fourth PCB.

FIG. 9B illustrates an embodiment of a sixth intermediate process stage.

FIG. 10A illustrates an embodiment of a seventh intermediate process stage.

FIG. 10B illustrates an embodiment of a eighth intermediate process stage.

FIG. 10C illustrates an embodiment of a ninth intermediate process stage.

FIG. 11A illustrates an embodiment of a tenth intermediate process stage.

FIG. 11B illustrates an embodiment of an eleventh intermediate process stage.

FIG. 12 illustrates an embodiment of a fourth assembly.

FIG. 13 illustrates an embodiment of a fifth assembly.

FIG. 14 illustrates an embodiment of a first logic flow.

FIG. 15 illustrates an embodiment of a second logic flow.

FIG. 16 illustrates an embodiment of a storage medium.

FIG. 17 illustrates an embodiment of a computing architecture.

FIG. 18 illustrates an embodiment of a system.

FIG. 19 illustrates an embodiment of a device.

### DETAILED DESCRIPTION

Various embodiments may be generally directed to attachment techniques for printed circuit boards (PCBs). According to some such techniques, an array of double-contact connectors may be used to attach first and second PCBs to each other. In various embodiments, each such double-contact connector may comprise respective first and second contact elements that establish and retain physical contact with the inner surfaces of vias in the first and second PCBs. In some embodiments, at least one of the double-contact connectors may provide electrical conductivity between a trace on the first PCB and a trace on the second PCB. In various embodiments, one of the two PCBs may comprise a main PCB, and the other may comprise a patch PCB arranged to relieve routing congestion in a region of the main PCB. In some embodiments, each double-contact connector in the array may comprise first and second contact elements of substantially equal widths. In various other embodiments, each double-contact connector in the array may comprise first and second contact elements that include a wider contact element and a narrower contact element. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

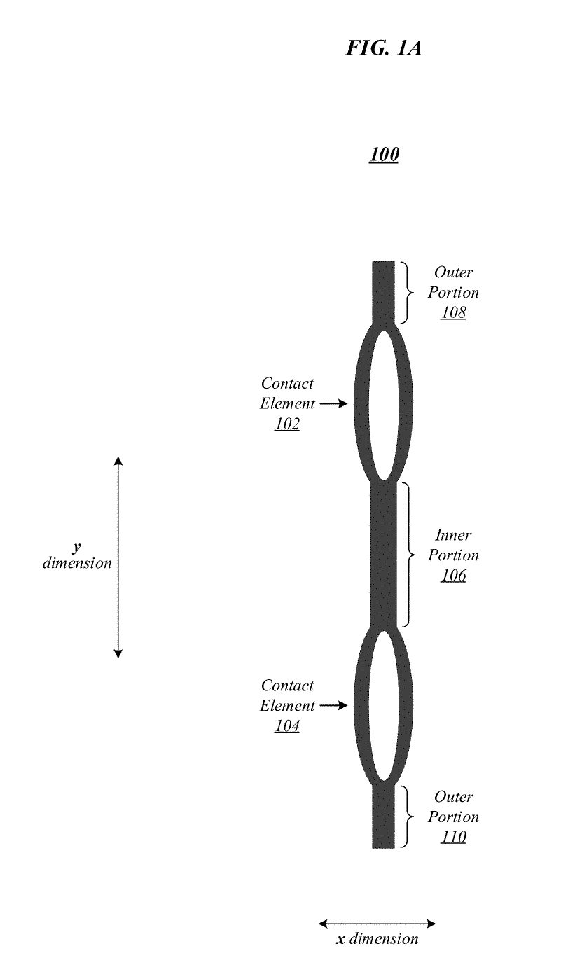

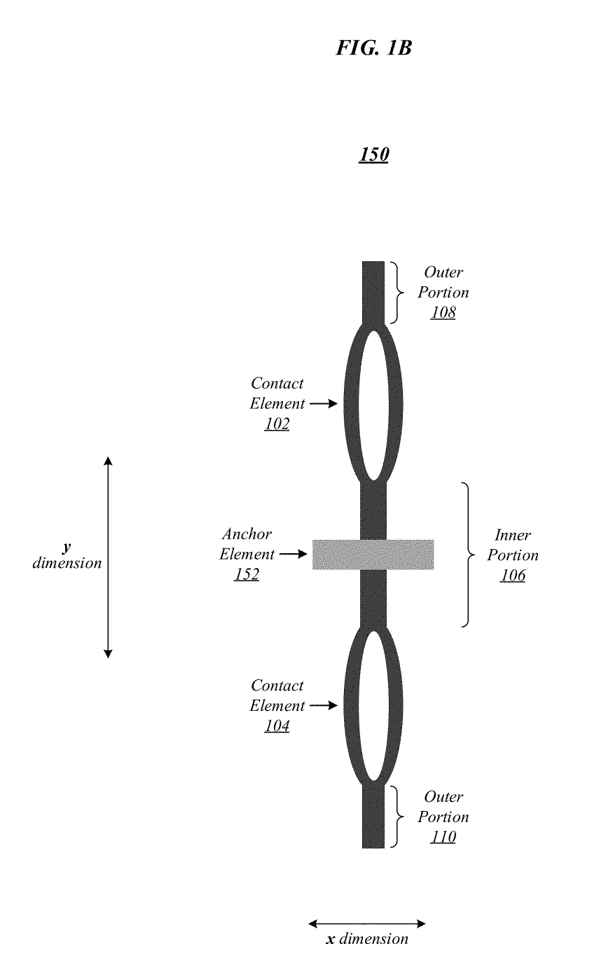

FIG. 1A illustrates an example of a double-contact connector 100. As shown in FIG. 1A, double-contact connector 100 comprises contact elements 102 and 104. Contact elements 102 and 104 may generally comprise structural elements designed to be inserted into holes in substrates, and to establish and retain physical contact with inner surfaces of such holes. For example, contact elements 102 and 104 may comprise structural elements designed to be inserted into vias or through-holes of printed circuit boards (PCBs), and to establish and retain physical contact with inner surfaces of such vias or through-holes. An x dimension is depicted at the bottom of FIG. 1A, as well as at the bottoms of various figures that follow. Hereinafter, the size of any given element with respect to this x dimension shall be referred to as that element's “width.” In the example of FIG. 1A, contact elements 102 and 104 comprise substantially equal widths. A y dimension is depicted on the left side of FIG. 1A, as well as on the left sides of various figures that follow. Hereinafter, the size of any given element with respect to the y dimension shall be referred to as that element's “length.” In various embodiments, as reflected in the example of FIG. 1A, contact elements 102 and 104 may comprise substantially equal lengths. In some other embodiments, contact elements 102 and 104 may comprise differing lengths. The embodiments are not limited in this context.

In various embodiments, double-contact connector 100 may comprise a double press-fit (PFT) pin, and contact elements 102 and 104 may comprise PFT contact elements. In some such embodiments, contact elements 102 and 104 may comprise PFT rings. In various embodiments, contact elements 102 and 104 may comprise PFT contact elements of other types/geometries. In some embodiments, contact element 102 may comprise a PFT contact element of a first type/geometry, and contact element 104 may comprise a PFT contact element of a second, different type/geometry. It is to be appreciated that in various embodiments, either or both of contact elements 102 and 104 may comprise an arrangement of multiple discrete sub-elements. It is also to be appreciated that in some embodiments, rather than comprising PFT contact elements, one or both of contact elements 102 and 104 may comprise a contact element of some other suitable type. The embodiments are not limited in this context.

In various embodiments, contact elements 102 and 104 may be connected by an inner portion 106 of double-contact connector 100. In some embodiments, an outer portion 108 of double-contact connecter 100 may extend from a substantially opposite side of contact element 102 with respect to the side of contact element 102 that meets inner portion 106. In various embodiments, an outer portion 110 of double-contact connecter 100 may extend from a substantially opposite side of contact element 104 with respect to the side of contact element 104 that meets inner portion 106. In some embodiments, double-contact connector 100 may comprise a unitary structure. In various other embodiments, may be comprised of multiple discrete elements. The embodiments are not limited in this context.

FIG. 1B illustrates an example of a double-contact connector 150. Like double-contact connector 100 of FIG. 1A, double-contact connector 150 may comprise contact elements 102 and 104, inner portion 106, and outer portions 108 and 110. Double-contact connector 150 may also comprise an anchoring element 152. Anchoring element 152 may generally comprise a structural element designed to be encased in, affixed to, or otherwise retained by a substrate in order to mechanically stabilize double-contact connector 150. In some embodiments, anchoring element 152 may comprise an anchor plate. In various other embodiments, anchoring element 152 may feature another suitable type of geometry. In some embodiments, anchoring element 152 may comprise a portion of a single unitary structure that also comprises some or all of the remaining portions of double-contact connector 150. For example, in various embodiments, anchoring element 152 may comprise a portion of a same unitary structure as inner portion 106. In some other embodiments, anchoring element 152 may comprise a discrete element. In various embodiments, anchoring element 152 may be comprised of the same material as inner portion 106. In some other embodiments, anchoring element 152 may be comprised of a different material than inner portion 106. The embodiments are not limited in this context.

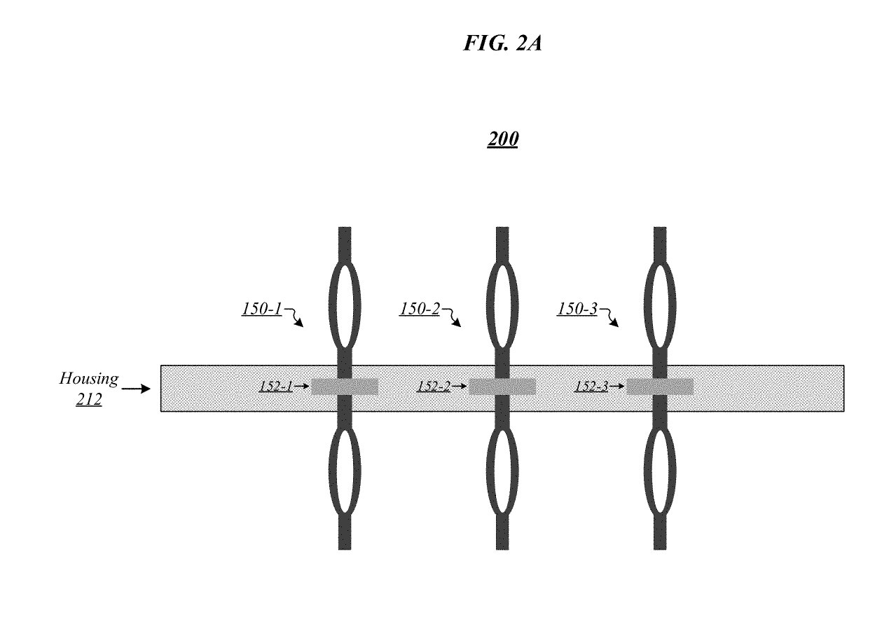

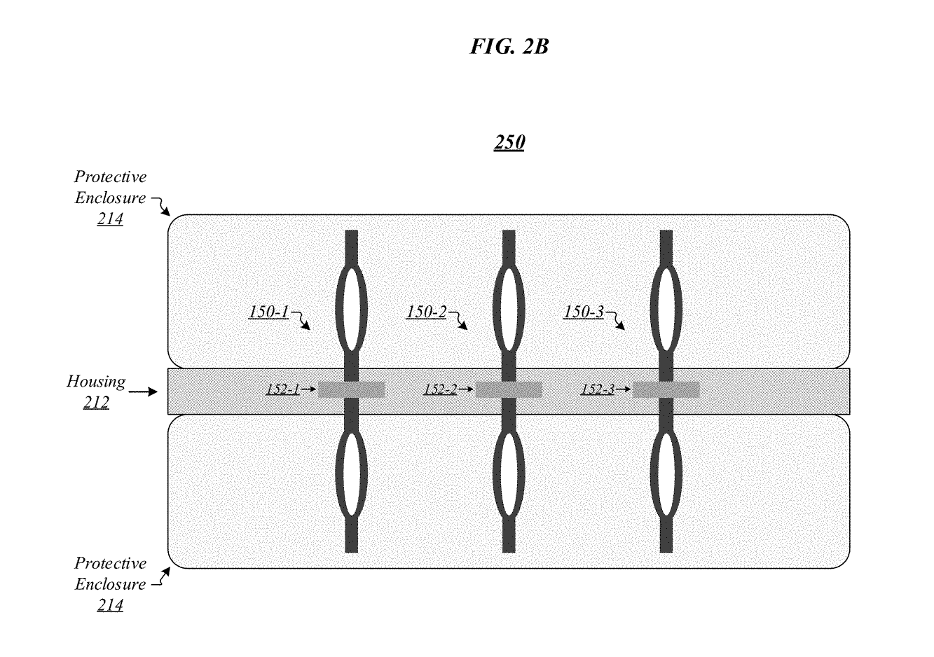

FIG. 2A illustrates an example of a connector array 200 that may be used to attach two PCBs to each other according to various embodiments. Connector array 200 features three double-contact connectors 150-1, 150-2, and 150-3, each of which may be the same as—or similar to—double-contact connector 150 of FIG. 1B. Anchoring elements 152-1, 152-2, and 152-3 are arranged to mechanically stabilize double-contact connectors 150-1, 150-2, and 150-3, respectively. Anchoring elements 152-1, 152-2, and 152-3 are each encased in a housing 212. In some embodiments, housing 212 may comprise a very low profile (VLP) or ultra-low profile (ULP) housing. It is worthy of note that the embodiments are not limited to the arrangement depicted in this example. In various embodiments, a connector array that is used to implement one or more of the disclosed PCB attachment techniques may comprise a greater or lesser number of double-contact connectors than does example connector array 200. In some embodiments, the double-sided connectors in a connector array that is used to implement one or more of the disclosed PCB attachment techniques may be arranged in a grid or another type of non-linear arrangement. The embodiments are not limited in this context.

FIG. 2B illustrates an example of an assembly 250. Assembly 250 may generally be formed via the placement/attachment of one or more protective elements onto connector array 200 of FIG. 2A. In various embodiments, such protective elements may be placed/attached onto connector array 200 of FIG. 2A in order to protect exposed portions of double-contact connectors 150-1, 150-2, and 150-3 from damage and/or contamination. In this example, protective enclosures 214 are generally arranged to protect respective exposed portions of double-contact connectors 150-1, 150-2, and 150-3 on both sides of housing 212. The embodiments are not limited to this example.

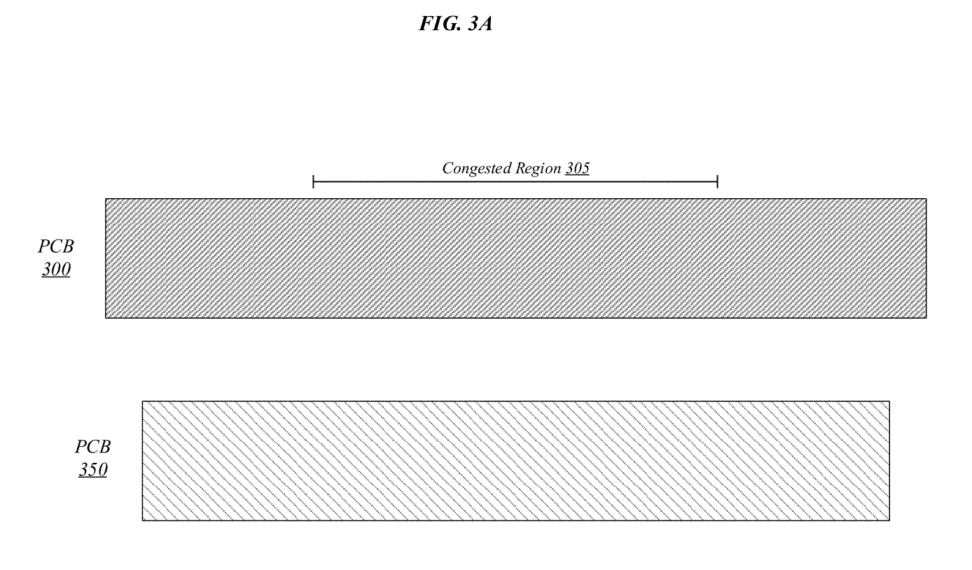

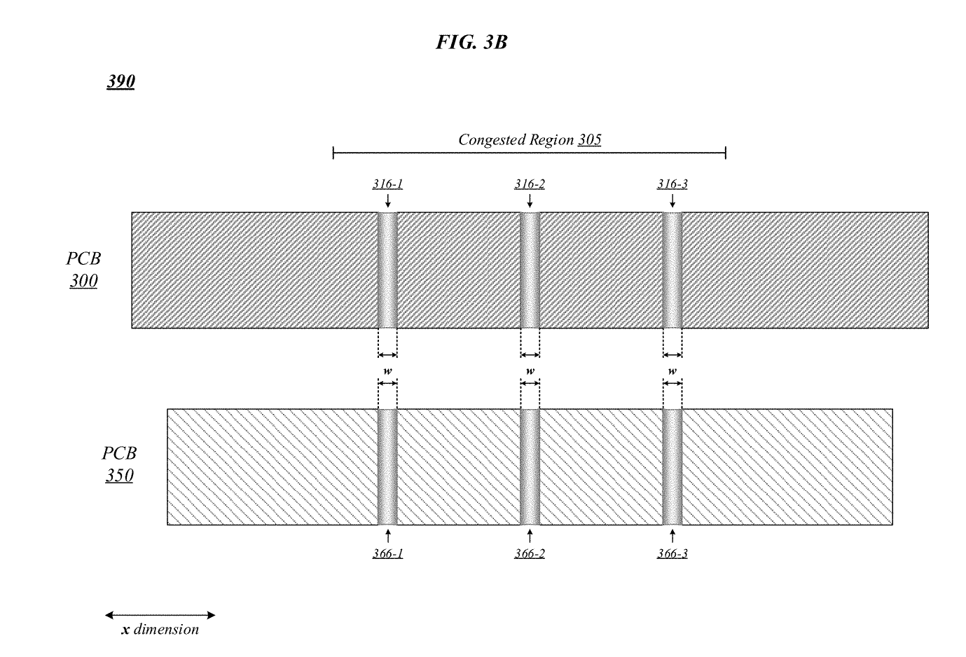

FIG. 3A illustrates an embodiment of a PCB 300 and an embodiment of a PCB 350. In some embodiments, it may generally be desirable to attach PCBs 300 and 350 to each other. In various embodiments, for example, it may be desirable to attach PCBs 300 and 350 to each other in conjunction with relieving routing congestion in a congestion region 305 of PCB 300. In some embodiments, PCB 300 may comprise a main PCB, and PCB 350 may comprise a patch PCB for use to relieve routing congestion in congestion region 305 of PCB 300. In various embodiments, PCB 350 may comprise a smaller two-dimensional footprint than does PCB 300. In some other embodiments, PCB 350 may comprise a substantially same two-dimensional footprint as does PCB 300 or a larger two-dimensional footprint than does PCB 300. It is to be appreciated that although contested region 305 is only depicted in one dimension in FIG. 3A, congested region 305 may comprise a two-dimensional region in various embodiments. The embodiments are not limited in this context.

FIG. 3B illustrates an embodiment of an intermediate process stage 390. Intermediate process stage 390 may generally be representative of a stage of a process for attaching PCBs 300 and 350 to each other according to one or more of the disclosed techniques. More particularly, intermediate process stage 390 may be representative of a stage at which a PCB preparation sub-process has been performed in order to prepare PCBs 300 and 350 for attachment via connector array 200 of FIG. 2A. As reflected in FIG. 3B, in some embodiments, the PCB preparation sub-process may generally involve configuring PCBs 300 and 350 with respective sets of vias. In this example, PCB 300 has been configured with vias 316-1, 316-2, and 316-3, each of which is generally located within congested region 305, and PCB 350 has been configured with vias 366-1, 366-2, and 366-3. Each of vias 316-1, 316-2, 316-3, 366-1, 366-2, and 366-3 comprises a substantially equal width w. In various embodiments, a value of w may be selected based on the substantially equal width of the various contact elements in connector array 200. It is to be appreciated that in some embodiments, vias 316-1, 316-2, 316-3, 366-1, 366-2, and 366-3 may be substantially cylindrical in shape, such that w corresponds to the diameters of vias 316-1, 316-2, 316-3, 366-1, 366-2, and 366-3. The embodiments are not limited in this context.

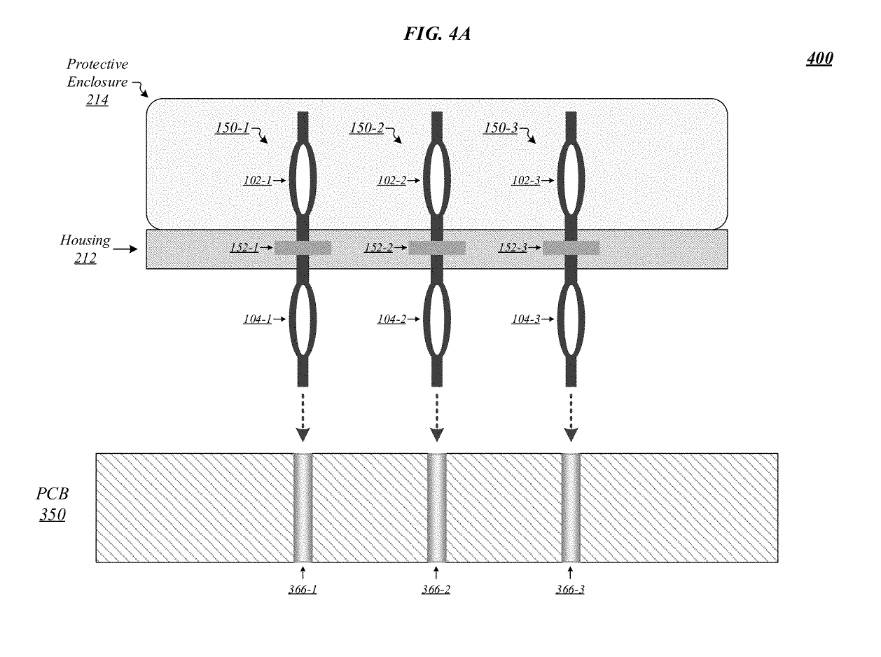

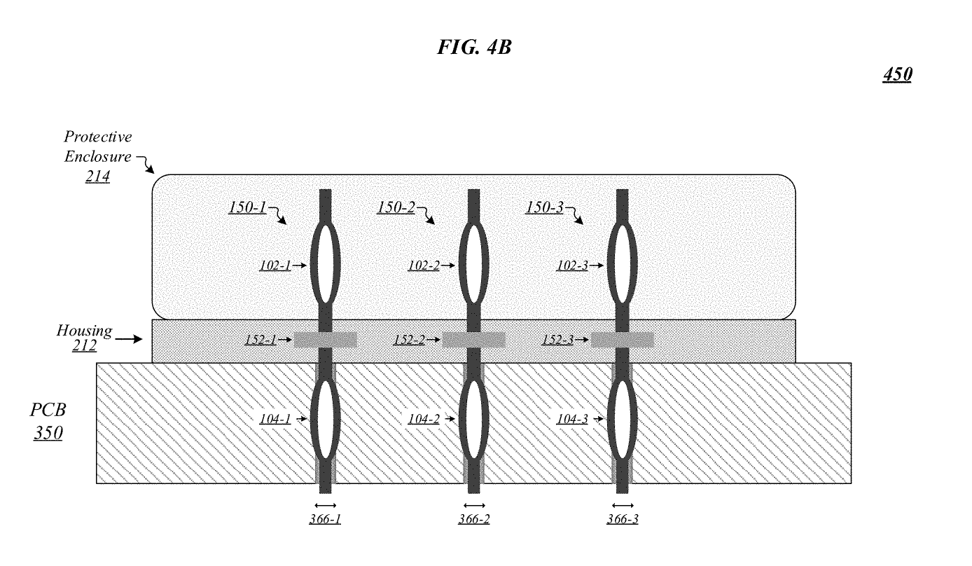

FIG. 4A illustrates an embodiment of an intermediate process stage 400. Intermediate process stage 400 may generally be representative of a stage of a process for attaching PCBs 300 and 350 to each other using connector array 200 of FIG. 2A. More particularly, intermediate process stage 400 may be representative of a first attachment sub-process, according to which connector array 200 may be attached to PCB 350. As reflected in FIG. 4A, according to such a first attachment sub-process in various embodiments, connector array 200 may generally be pressed into PCB 350 while contact elements 104-1, 104-2, and 104-3 are substantially aligned with vias 366-1, 366-2, and 366-3, respectively. In some other embodiments, PCB 350 may be pressed onto connector array 200. In yet other embodiments, connector array 200 and PCB 350 may be concurrently pressed towards each other. In various embodiments, prior to initiation of the first attachment sub-process, portions of connector array 200 including contact elements 104-1, 104-2, and 104-3 may be covered by a protective enclosure, and that protective enclosure may be removed in order to enable the attachment of connector array 200 and PCB 350 to each other. In some such embodiments, a protective enclosure 214 that covers portions of connector array 200 including contact elements 102-1, 102-2, and 102-3 may be left in place in order to protect those portions of connector array 200 during the first attachment sub-process. The embodiments are not limited in this context.

FIG. 4B illustrates an embodiment of an intermediate process stage 450. Intermediate process stage 450 may generally be representative of a stage of a process for attaching PCBs 300 and 350 to each other using connector array 200 of FIG. 2A. More particularly, intermediate process stage 450 may be representative of a stage at which the first attachment sub-process depicted in FIG. 4A has been completed. As reflected in FIG. 4B, following completion of the first attachment sub-process, contact elements 104-1, 104-2, and 104-3 may be generally seated within vias 366-1, 366-2, and 366-3 respectively. In various embodiments, contact elements 104-1, 104-2, and 104-3 may contact inner surfaces of vias 366-1, 366-2, and 366-3. In some embodiments, the insertion of contact elements 104-1, 104-2, and 104-3 into vias 366-1, 366-2, and 366-3 may compress contact elements 104-1, 104-2, and 104-3. In various such embodiments, contact elements 104-1, 104-2, and 104-3 may possess some degree of elasticity, such that they exert outward force upon the inner surfaces of vias 366-1, 366-2, and 366-3 while compressed therein. In some embodiments, the inner surfaces of one or more of vias 366-1, 366-2, and 366-3 may be comprised of conductive material. In various such embodiments, the insertion of a contact element of any given one of double-contact connectors 150-1, 150-2, and 150-3 into a via featuring an inner surface comprising conductive material may electrically couple that double-contact connector with that conductive material. The embodiments are not limited in this context.

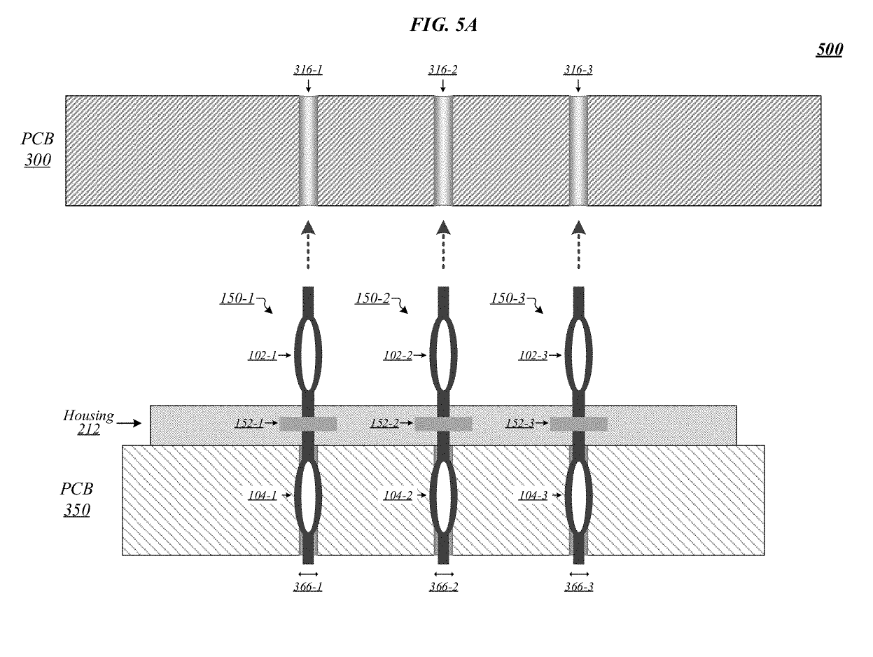

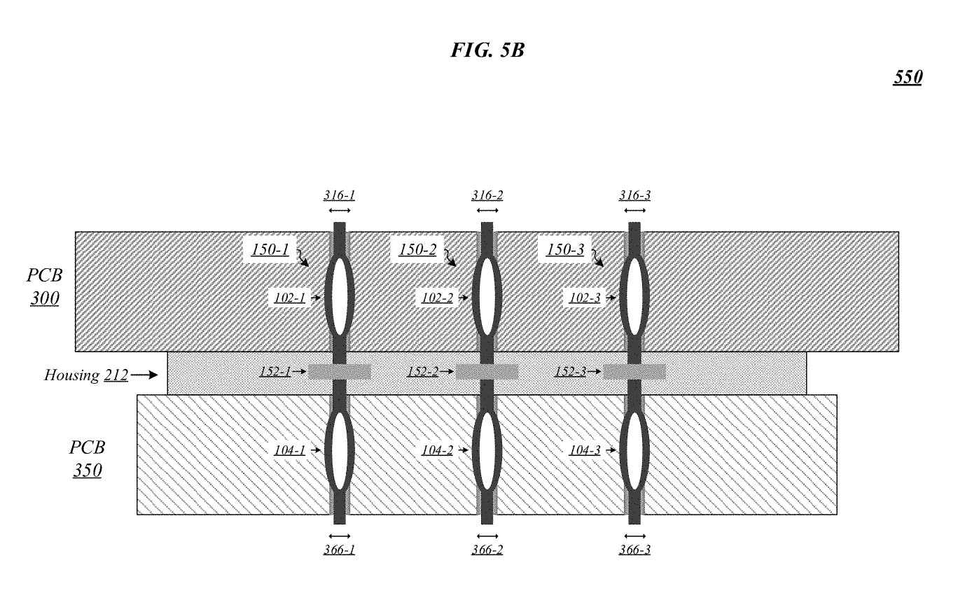

FIG. 5A illustrates an embodiment of an intermediate process stage 500. Intermediate process stage 500 may generally be representative of a stage of a process for attaching PCBs 300 and 350 to each other using connector array 200 of FIG. 2A. More particularly, intermediate process stage 500 may be representative of a second attachment sub-process, according to which connector array 200 may be attached to PCB 300. As reflected in FIG. 5A, according to such a second attachment sub-process in some embodiments, connector array 200 may generally be pressed into PCB 300 while contact elements 102-1, 102-2, and 102-3 are substantially aligned with vias 316-1, 316-2, and 316-3, respectively. In various other embodiments, PCB 300 may be pressed into connector array 200. In yet other embodiments, connector array 200 and PCB 300 may be concurrently pressed into each other. In some embodiments, prior to initiation of the second attachment sub-process, portions of connector array 200 including contact elements 102-1, 102-2, and 102-3 may be covered by a protective enclosure, and that protective enclosure may be removed in order to enable the attachment of connector array 200 and PCB 300 to each other. The embodiments are not limited in this context.

FIG. 5B illustrates an embodiment of an intermediate process stage 550. Intermediate process stage 550 may generally be representative of a stage of a process for attaching PCBs 300 and 350 to each other using connector array 200 of FIG. 2A. More particularly, intermediate process stage 550 may be representative of a stage at which the second attachment sub-process depicted in FIG. 5A has been completed. As reflected in FIG. 5B, following completion of the second attachment sub-process, contact elements 102-1, 102-2, and 102-3 may be generally seated within vias 316-1, 316-2, and 316-3 respectively. In various embodiments, contact elements 102-1, 102-2, and 102-3 may contact inner surfaces of vias 316-1, 316-2, and 316-3. In some embodiments, the insertion of contact elements 102-1, 102-2, and 102-3 into vias 316-1, 316-2, and 316-3 may compress contact elements 102-1, 102-2, and 102-3. In various such embodiments, contact elements 102-1, 102-2, and 102-3 may possess some degree of elasticity, such that they exert outward force upon the inner surfaces of vias 316-1, 316-2, and 316-3 while compressed therein. In some embodiments, the inner surfaces of one or more of vias 316-1, 316-2, and 316-3 may be comprised of conductive material. In various such embodiments, the insertion of a contact element of any given one of double-contact connectors 150-1, 150-2, and 150-3 into a via featuring an inner surface comprising conductive material may electrically couple that double-contact connector with that conductive material. The embodiments are not limited in this context.

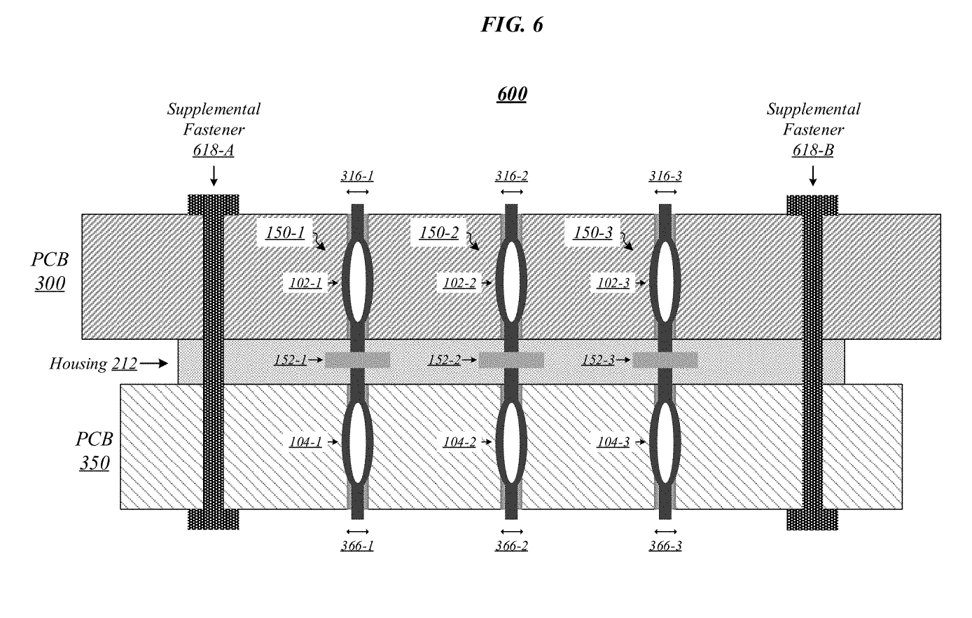

FIG. 6 illustrates an embodiment of an assembly 600. Assembly 600 may generally be representative of an assembly that is formed by using connector array 200 of FIG. 2A to attach PCBs 300 and 350 to each other. More particularly, assembly 600 may be representative of an assembly that is formed via the first and second attachment sub-processes depicted in FIGS. 4A and 5A. In assembly 600, contact elements 102-1, 102-2, and 102-3 are seated within respective vias 316-1, 316-2, and 316-3 of PCB 300, and contact elements 104-1, 104-2, and 104-3 are seated within respective vias 366-1, 366-2, and 366-3 of PCB 350. In some embodiments, assembly 600 may feature one or more supplemental fasteners, such as the supplemental fasteners 618-A and 618-B depicted in the example of FIG. 6. In various embodiments, supplemental fasteners 618-A and 618-B may provide assembly 600 with enhanced mechanical stability and/or may aid in proper alignment of the various layers of assembly 600. In some embodiments, supplemental fasteners 618-A and 618-B may comprise screws or bolts. It is worthy of note that although the outer portions of double-contact connectors 150-1, 150-2, and 150-3 are depicted as protruding from the vias of PCBs 300 and 350 in FIG. 6, the embodiments are not limited to this example. In various embodiments, for example, in order to mitigate stub effects, it may be desirable that assembly 600 be designed such that one or more outer portions of double-contact connectors 150-1, 150-2, and 150-3 terminate within their corresponding vias rather than protruding therefrom. The embodiments are not limited in this context.

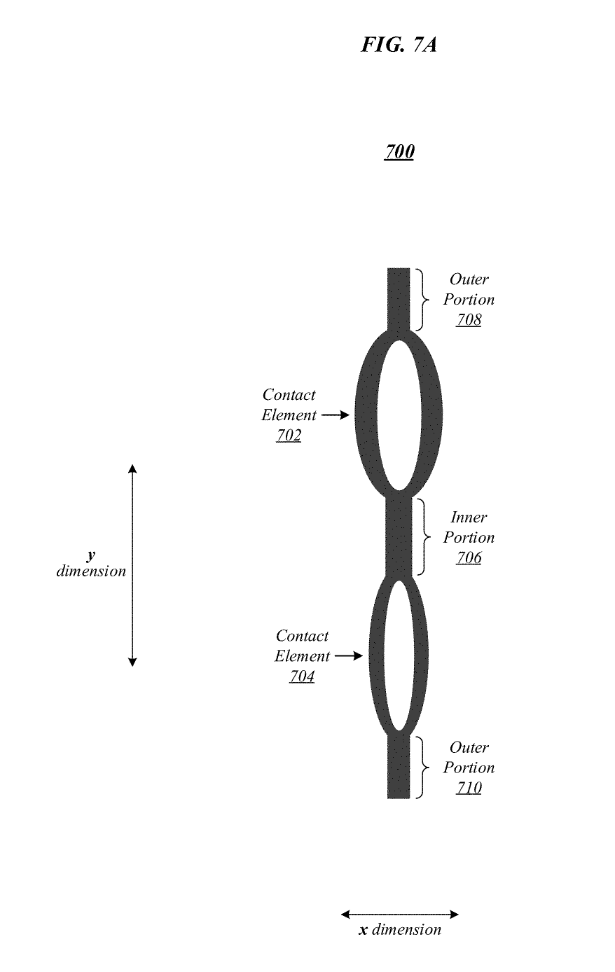

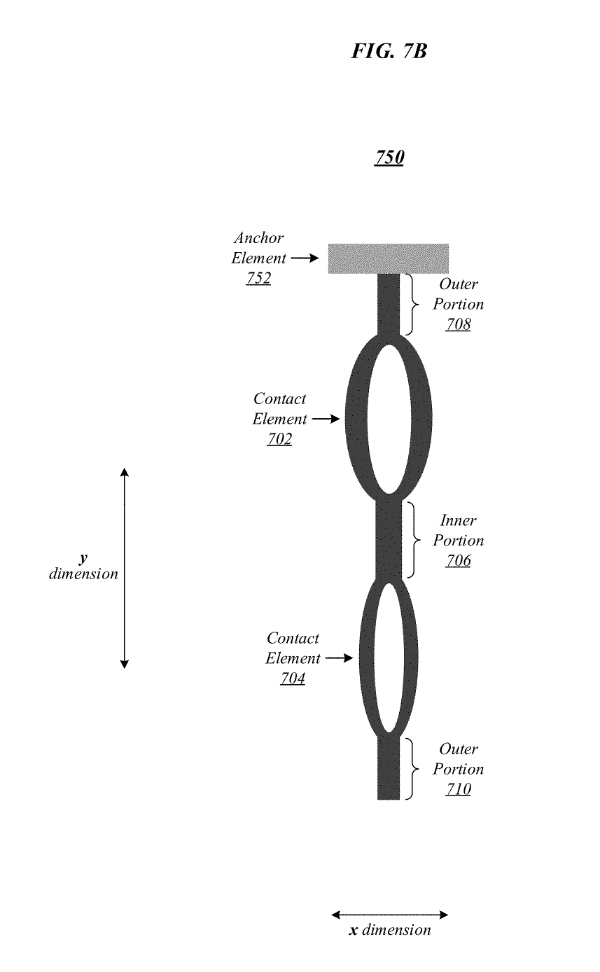

FIG. 7A illustrates an example of a double-contact connector 700. As shown in FIG. 7A, double-contact connector 700 comprises contact elements 702 and 704. Contact elements 702 and 704 may generally comprise structural elements designed to be inserted into holes in substrates, and to establish and retain physical contact with inner surfaces of such holes. For example, contact elements 702 and 704 may comprise structural elements designed to be inserted into vias or through-holes of printed circuit boards (PCBs), and to establish and retain physical contact with inner surfaces of such vias or through-holes. In the example of FIG. 7A, contact element 702 comprises a substantially greater width than does contact element 704. In various embodiments, as reflected in the example of FIG. 7A, contact elements 702 and 704 may comprise substantially equal lengths. In some other embodiments, contact elements 702 and 704 may comprise differing lengths. The embodiments are not limited in this context.

In various embodiments, double-contact connector 700 may comprise a double press-fit (PFT) pin, and contact elements 702 and 704 may comprise PFT contact elements. In some such embodiments, contact elements 702 and 704 may comprise PFT rings. In various embodiments, contact elements 702 and 704 may comprise PFT contact elements of other types/geometries. In some embodiments, contact element 702 may comprise a PFT contact element of a first type/geometry, and contact element 704 may comprise a PFT contact element of a second, different type/geometry. It is to be appreciated that in various embodiments, either or both of contact elements 702 and 704 may comprise an arrangement of multiple discrete sub-elements. It is also to be appreciated that in some embodiments, rather than comprising PFT contact elements, one or both of contact elements 702 and 704 may comprise a contact element of some other suitable type. The embodiments are not limited in this context.

In various embodiments, contact elements 702 and 704 may be connected by an inner portion 706 of double-contact connector 700. In some embodiments, an outer portion 708 of double-contact connecter 700 may extend from a substantially opposite side of contact element 702 with respect to the side of contact element 702 that meets inner portion 706. In various embodiments, an outer portion 710 of double-contact connecter 700 may extend from a substantially opposite side of contact element 704 with respect to the side of contact element 704 that meets inner portion 706. In some embodiments, double-contact connector 700 may comprise a unitary structure. In various other embodiments, may be comprised of multiple discrete elements. The embodiments are not limited in this context.

FIG. 7B illustrates an example of a double-contact connector 750. Like double-contact connector 700 of FIG. 7A, double-contact connector 750 may comprise contact elements 702 and 704, inner portion 706, and outer portions 708 and 710. Double-contact connector 750 may also comprise an anchoring element 752. Anchoring element 752 may generally comprise a structural element designed to be encased in, affixed to, or otherwise retained by a substrate in order to mechanically stabilize double-contact connector 750. In some embodiments, anchoring element 752 may comprise an anchor plate. In various other embodiments, anchoring element 752 may feature another suitable type of geometry. In some embodiments, anchoring element 752 may comprise a portion of a single unitary structure that also comprise some or all of the remaining portions of double-contact connector 750. For example, in various embodiments, anchoring element 752 may comprise a portion of a same unitary structure as outer portion 708. In some other embodiments, anchoring element 752 may comprise a discrete element. In various embodiments, anchoring element 752 may be comprised of the same material as outer portion 708. In some other embodiments, anchoring element 752 may be comprised of a different material than outer portion 708. The embodiments are not limited in this context.

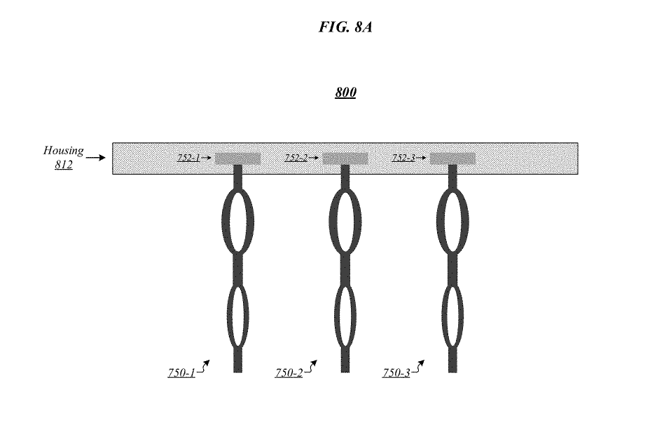

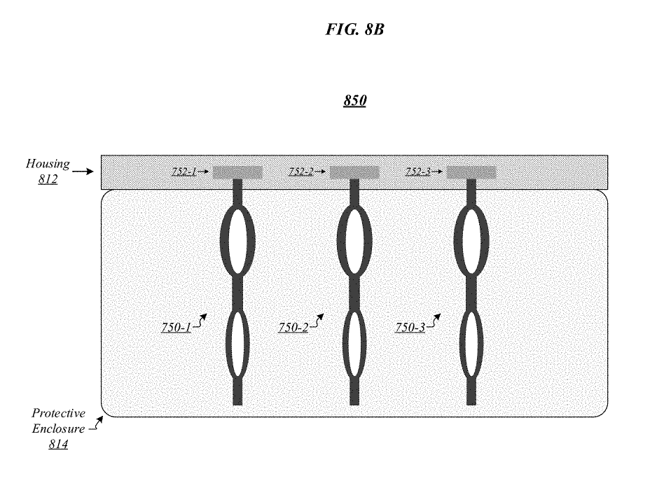

FIG. 8A illustrates an example of a connector array 800 that may be used to attach two PCBs to each other according to various embodiments. Connector array 800 features three double-contact connectors 750-1, 750-2, and 750-3, each of which may be the same as—or similar to—double-contact connector 750 of FIG. 7B. Anchoring elements 752-1, 752-2, and 752-3 are arranged to mechanically stabilize double-contact connectors 750-1, 750-2, and 750-3, respectively. Anchoring elements 752-1, 752-2, and 752-3 are each encased in a housing 712. In some embodiments, housing 712 may comprise a very low profile (VLP) or ultra-low profile (ULP) housing. It is worthy of note that the embodiments are not limited to the arrangement depicted in this example. In various embodiments, a connector array that is used to implement one or more of the disclosed PCB attachment techniques may comprise a greater or lesser number of double-contact connectors than does example connector array 800. In some embodiments, the double-sided connectors in a connector array that is used to implement one or more of the disclosed PCB attachment techniques may be arranged in a grid or another type of non-linear arrangement. The embodiments are not limited in this context.

FIG. 8B illustrates an example of an assembly 850. Assembly 850 may generally be formed via the placement/attachment of one or more protective elements onto connector array 800 of FIG. 8A. In various embodiments, such protective elements may be placed/attached onto connector array 800 of FIG. 8A in order to protect exposed portions of double-contact connectors 750-1, 750-2, and 750-3 from damage and/or contamination. In this example, a protective enclosure 814 is generally arranged to protect respective exposed portions of double-contact connectors 150-1, 150-2, and 150-3. The embodiments are not limited to this example.

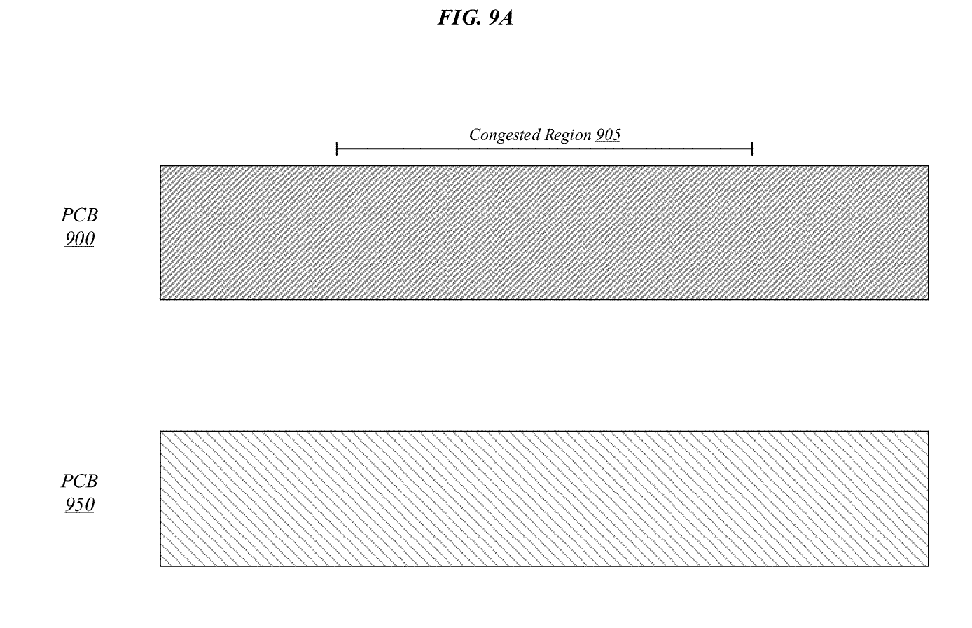

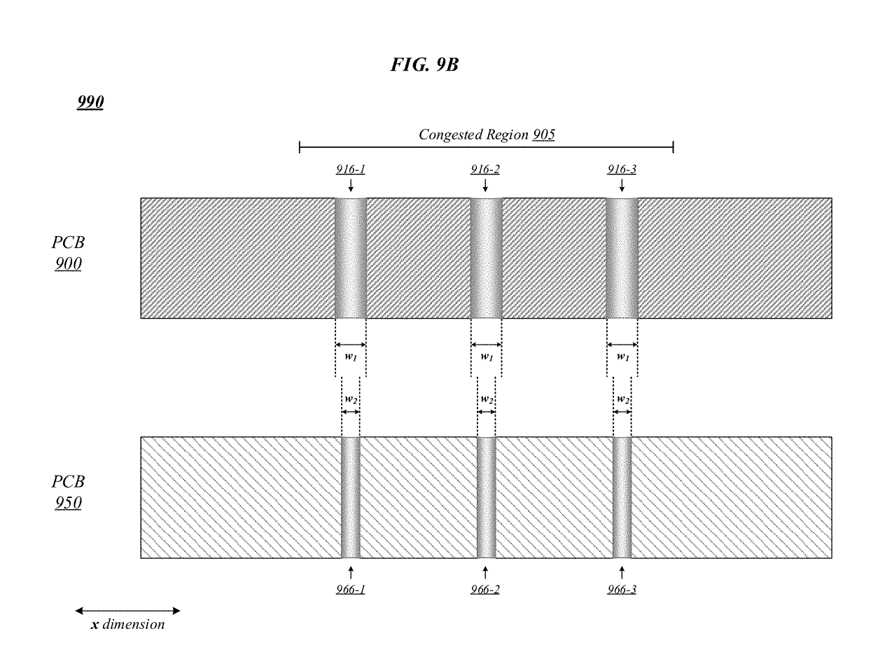

FIG. 9A illustrates an embodiment of a PCB 900 and an embodiment of a PCB 950. In some embodiments, it may generally be desirable to attach PCBs 900 and 950 to each other. In various embodiments, for example, it may be desirable to attach PCBs 900 and 950 to each other in conjunction with relieving routing congestion in a congestion region 905 of PCB 900. In some embodiments, PCB 900 may comprise a main PCB, and PCB 950 may comprise a patch PCB for use to relieve routing congestion in congestion region 905 of PCB 900. In various embodiments, PCB 950 may comprise a substantially same two-dimensional footprint as does PCB 900. In some other embodiments, PCB 950 may comprise a smaller two-dimensional footprint than does PCB 900 or a larger two-dimensional footprint than does PCB 900. It is to be appreciated that although contested region 905 is only depicted in one dimension in FIG. 9A, congested region 905 may comprise a two-dimensional region in various embodiments. The embodiments are not limited in this context.

FIG. 9B illustrates an embodiment of an intermediate process stage 990. Intermediate process stage 990 may generally be representative of a stage of a process for attaching PCBs 900 and 950 to each other according to one or more of the disclosed techniques. More particularly, intermediate process stage 990 may be representative of a stage at which a PCB preparation sub-process has been performed in order to prepare PCBs 900 and 950 for attachment via connector array 800 of FIG. 8A. As reflected in FIG. 9B, in some embodiments, the PCB preparation sub-process may generally involve configuring PCBs 900 and 950 with respective sets of vias. In this example, PCB 900 has been configured with vias 916-1, 916-2, and 916-3, each of which is generally located within congested region 905, and PCB 950 has been configured with vias 966-1, 966-2, and 966-3. Each of vias 916-1, 916-2, and 916-3 comprises a substantially equal width w₁. Each of vias 966-1, 966-2, and 966-3 comprises a substantially equal width w₂ that is less than w₁. In various embodiments, values of w₁ and W₂ may be selected based on the widths of the various contact elements in connector array 800. It is to be appreciated that in some embodiments, vias 916-1, 916-2, 916-3, 966-1, 966-2, and 966-3 may be substantially cylindrical in shape, such that w₁ corresponds to the diameters of vias 916-1, 916-2, and 916-3, and w₂ corresponds to the diameters of vias 966-1, 966-2, and 966-3. The embodiments are not limited in this context.

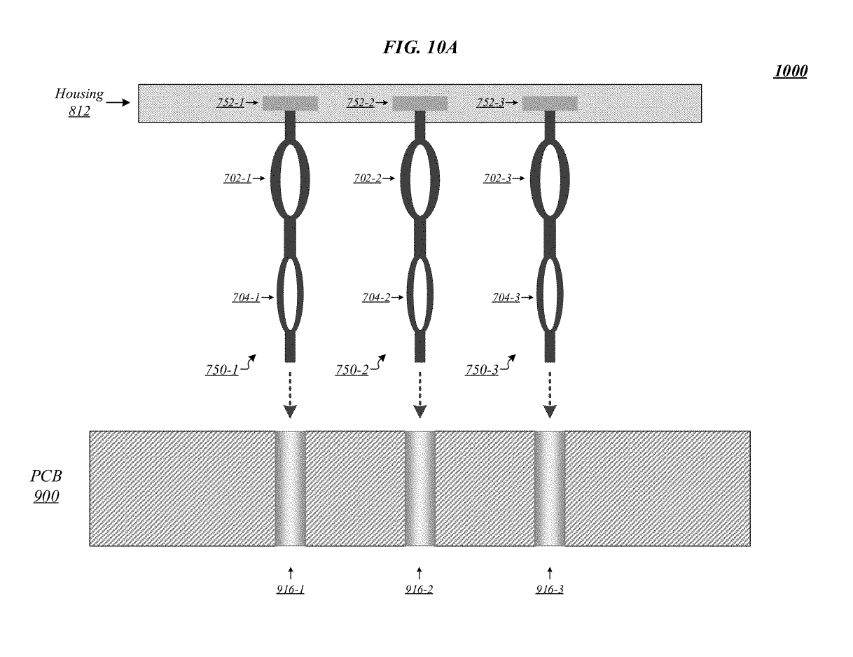

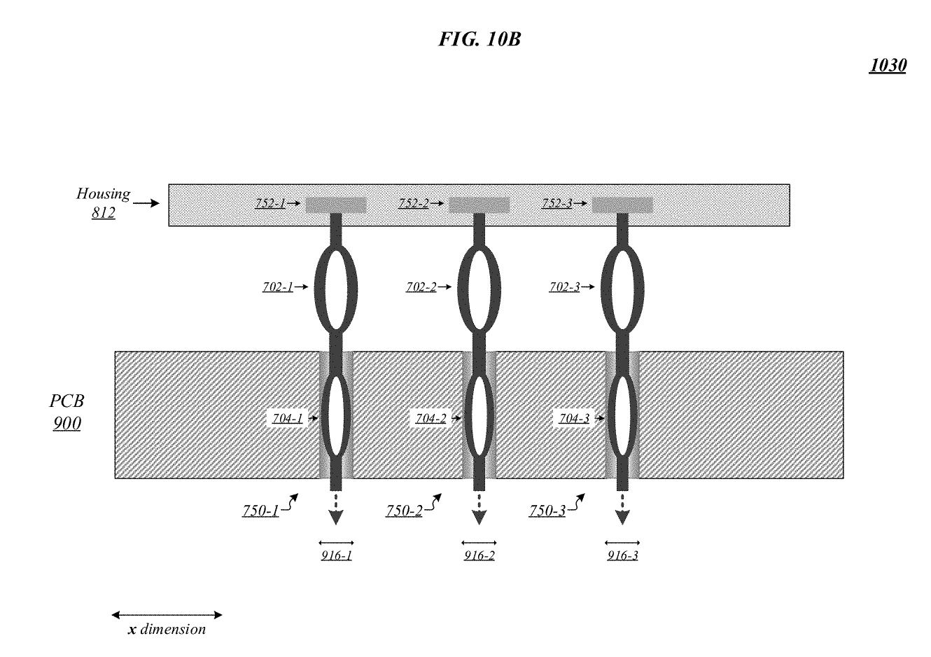

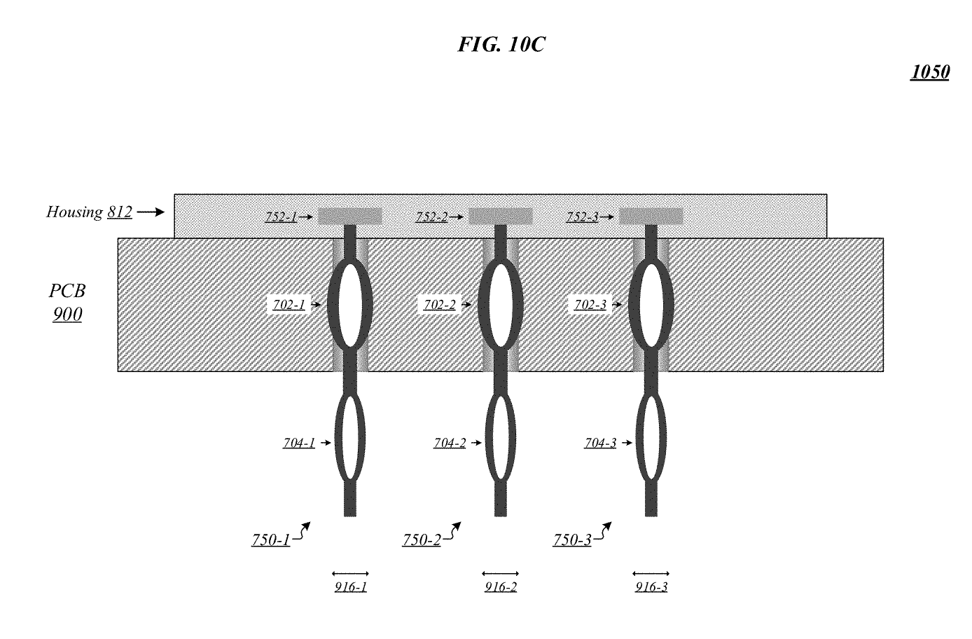

FIG. 10A illustrates an embodiment of an intermediate process stage 1000. Intermediate process stage 1000 may generally be representative of a stage of a process for attaching PCBs 900 and 950 to each other using connector array 800 of FIG. 8A. More particularly, intermediate process stage 1000 may be representative of a first attachment sub-process, according to which connector array 800 may be attached to PCB 900. As reflected in FIG. 10A, according to such a first attachment sub-process in various embodiments, connector array 800 may generally be pressed into PCB 900 while double-contact connectors 750-1, 750-2, and 750-3 are substantially aligned with vias 916-1, 916-2, and 916-3, respectively. In some other embodiments, PCB 900 may be pressed onto connector array 800. In yet other embodiments, connector array 800 and PCB 900 may be concurrently pressed towards each other. In various embodiments, prior to initiation of the first attachment sub-process, portions of connector array 800 may be covered by a protective enclosure, and that protective enclosure may be removed in order to enable the attachment of connector array 800 and PCB 900 to each other. The embodiments are not limited in this context.

FIG. 10B illustrates an embodiment of an intermediate process stage 1030. Intermediate process stage 1030 may generally be representative of a stage of a process for attaching PCBs 900 and 950 to each other using connector array 800 of FIG. 8A. More particularly, intermediate process stage 1030 may be representative of a stage at which the first attachment sub-process depicted in FIG. 10A is ongoing. As shown in FIG. 10B, at intermediate process stage 1030, double-contact connectors 750-1, 750-2, and 750-3 have been partially inserted into vias 916-1, 916-2, and 916-3, such that contact elements 704-1, 704-2, and 704-3 generally reside within vias 916-1, 916-2, and 916-3, respectively. The widths of vias 916-1, 916-2, and 916-3 may be selected such that contact elements 704-1, 704-2, and 704-3 are able to pass through vias 916-1, 916-2, and 916-3 without encountering significant contact with/compression by vias 916-1, 916-2, and 916-3. The embodiments are not limited in this context.

FIG. 10C illustrates an embodiment of an intermediate process stage 1050. Intermediate process stage 1050 may generally be representative of a stage of a process for attaching PCBs 900 and 950 to each other using connector array 800 of FIG. 8A. More particularly, intermediate process stage 1050 may be representative of a stage at which the first attachment sub-process depicted in FIGS. 10A and 10B has been completed. As reflected in FIG. 10C, following completion of the first attachment sub-process, contact elements 702-1, 702-2, and 702-3 may be generally seated within vias 916-1, 916-2, and 916-3 respectively. In some embodiments, contact elements 702-1, 702-2, and 702-3 may contact inner surfaces of vias 916-1, 916-2, and 916-3. In various embodiments, the insertion of contact elements 702-1, 702-2, and 702-3 into vias 916-1, 916-2, and 916-3 may compress contact elements 702-1, 702-2, and 702-3. In some such embodiments, contact elements 702-1, 702-2, and 702-3 may possess some degree of elasticity, such that they exert outward force upon the inner surfaces of vias 916-1, 916-2, and 916-3 while compressed therein. In various embodiments, the inner surfaces of one or more of vias 916-1, 916-2, and 916-3 may be comprised of conductive material. In some such embodiments, the insertion of a contact element of any given one of double-contact connectors 750-1, 750-2, and 750-3 into a via featuring an inner surface comprising conductive material may electrically couple that double-contact connector with that conductive material. The embodiments are not limited in this context.

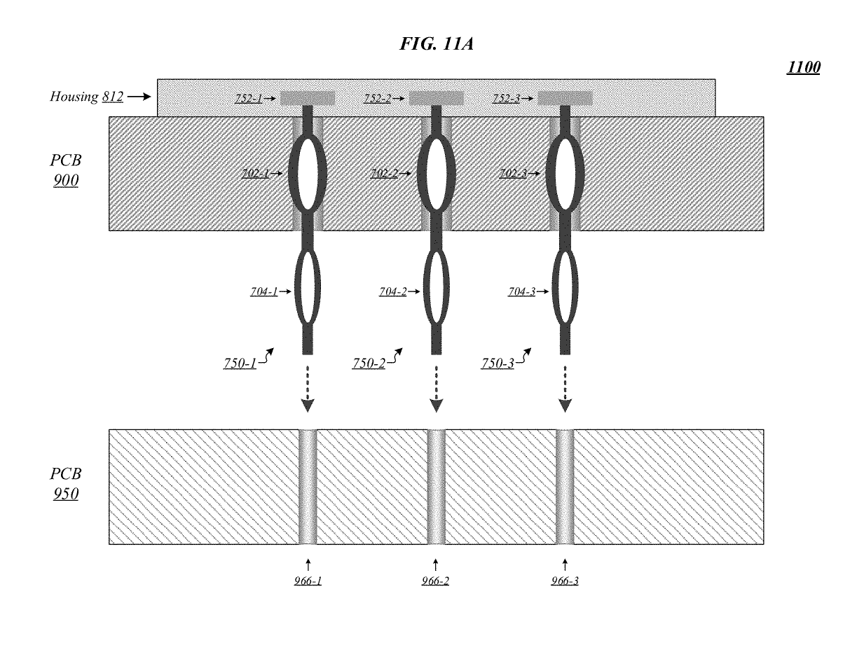

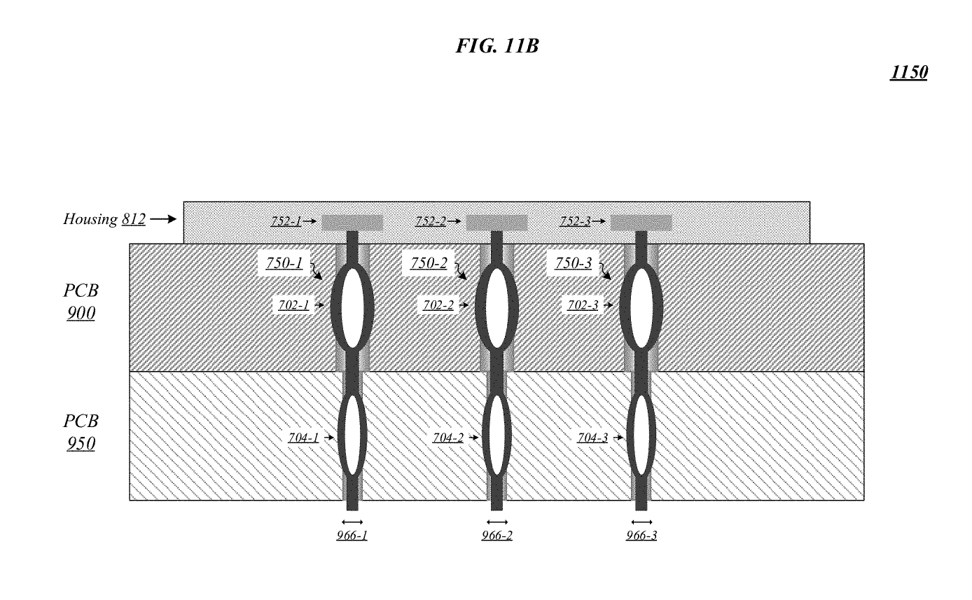

FIG. 11A illustrates an embodiment of an intermediate process stage 1100. Intermediate process stage 1100 may generally be representative of a stage of a process for attaching PCBs 900 and 950 to each other using connector array 800 of FIG. 8A. More particularly, intermediate process stage 1100 may be representative of a second attachment sub-process, according to which connector array 800 may be attached to PCB 950. As reflected in FIG. 11A, according to such a second attachment sub-process in various embodiments, connector array 800 may generally be pressed into PCB 950 while contact elements 704-1, 704-2, and 704-3 are substantially aligned with vias 966-1, 966-2, and 966-3, respectively. In some other embodiments, PCB 950 may be pressed onto connector array 800. In yet other embodiments, connector array 800 and PCB 950 may be concurrently pressed towards each other. The embodiments are not limited in this context.

FIG. 11B illustrates an embodiment of an intermediate process stage 1150. Intermediate process stage 1150 may generally be representative of a stage of a process for attaching PCBs 900 and 950 to each other using connector array 800 of FIG. 8A. More particularly, intermediate process stage 1150 may be representative of a stage at which the second attachment sub-process depicted in FIG. 11A has been completed. As reflected in FIG. 11B, following completion of the second attachment sub-process, contact elements 704-1, 704-2, and 704-3 may be generally seated within vias 966-1, 966-2, and 966-3 respectively. In various embodiments, contact elements 704-1, 704-2, and 704-3 may contact inner surfaces of vias 966-1, 966-2, and 966-3. In some embodiments, the insertion of contact elements 704-1, 704-2, and 704-3 into vias 966-1, 966-2, and 966-3 may compress contact elements 704-1, 704-2, and 704-3. In various such embodiments, contact elements 704-1, 704-2, and 704-3 may possess some degree of elasticity, such that they exert outward force upon the inner surfaces of vias 966-1, 966-2, and 966-3 while compressed therein. In some embodiments, the inner surfaces of one or more of vias 966-1, 966-2, and 966-3 may be comprised of conductive material. In various such embodiments, the insertion of a contact element of any given one of double-contact connectors 750-1, 750-2, and 750-3 into a via featuring an inner surface comprising conductive material may electrically couple that double-contact connector with that conductive material. The embodiments are not limited in this context.

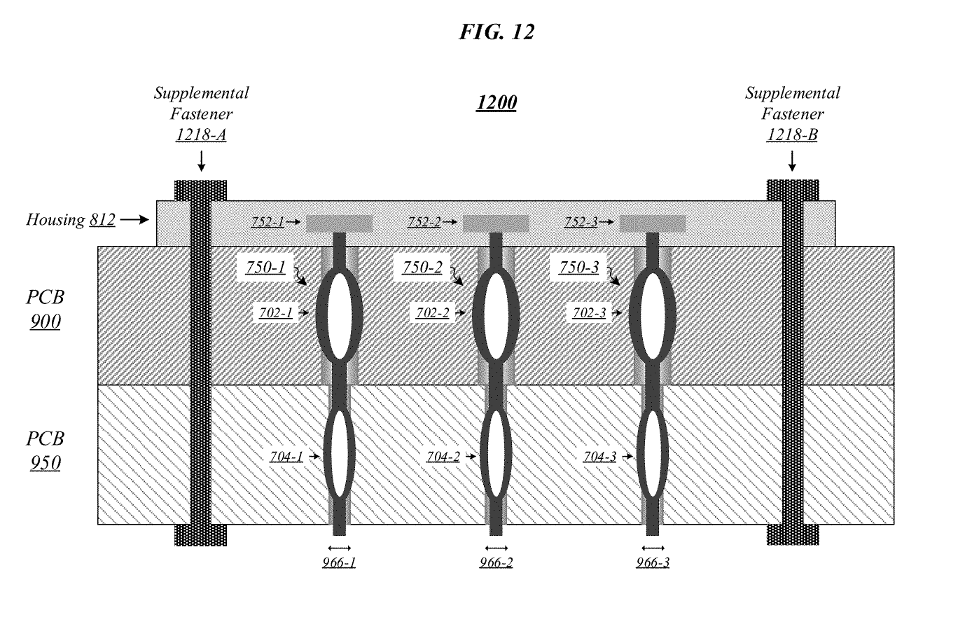

FIG. 12 illustrates an embodiment of an assembly 1200. Assembly 1200 may generally be representative of an assembly that is formed by using connector array 800 of FIG. 8A to attach PCBs 900 and 950 to each other. More particularly, assembly 1200 may be representative of an assembly that is formed via the first and second attachment sub-processes depicted in FIGS. 10A and 11A. In assembly 1200, contact elements 702-1, 702-2, and 702-3 are seated within respective vias 916-1, 916-2, and 916-3 of PCB 900, and contact elements 704-1, 704-2, and 704-3 are seated within respective vias 966-1, 966-2, and 966-3 of PCB 950. In some embodiments, assembly 1200 may feature one or more supplemental fasteners, such as the supplemental fasteners 1218-A and 1218-B depicted in the example of FIG. 12. In various embodiments, supplemental fasteners 1218-A and 1218-B may provide assembly 1200 with enhanced mechanical stability and/or may aid in proper alignment of the various layers of assembly 1200. In some embodiments, supplemental fasteners 1218-A and 1218-B may comprise screws or bolts. It is worthy of note that although outer portions of double-contact connectors 750-1, 750-2, and 750-3 are depicted as protruding from respective vias 966-1, 966-2, and 966-3 of PCB 950 in FIG. 12, the embodiments are not limited to this example. In various embodiments, for example, in order to mitigate stub effects, it may be desirable that assembly 1200 be designed such that some or all of those outer portions of double-contact connectors 750-1, 750-2, and 750-3 terminate within their corresponding vias rather than protruding therefrom. The embodiments are not limited to these examples.

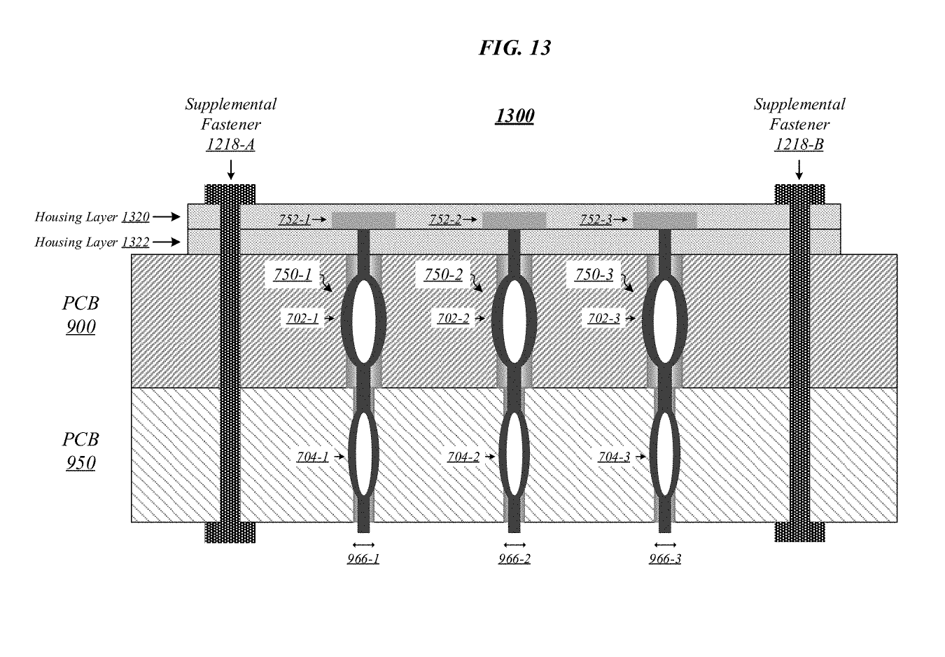

FIG. 13 illustrates an embodiment of an assembly 1300. Like assembly 1200 of FIG. 12, assembly 1300 may generally be representative of an assembly that is formed by using a connector array comprising double-contact connectors to attach PCBs 900 and 950 to each other. However, assembly 1300 may be formed using a connector array that comprises multiple housing layers 1320 and 1322. In various embodiments, anchoring elements 752-1, 752-2, and 752-3 may be encased in housing layer 1320. In some embodiments, housing layer 1322 may be positioned between housing layer 1320 and PCB 900. In various embodiments, portions of double-contact connectors may pass through holes in housing layer 1322 to meet anchoring elements 752-1, 752-2, and 752-3 in housing layer 1320. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

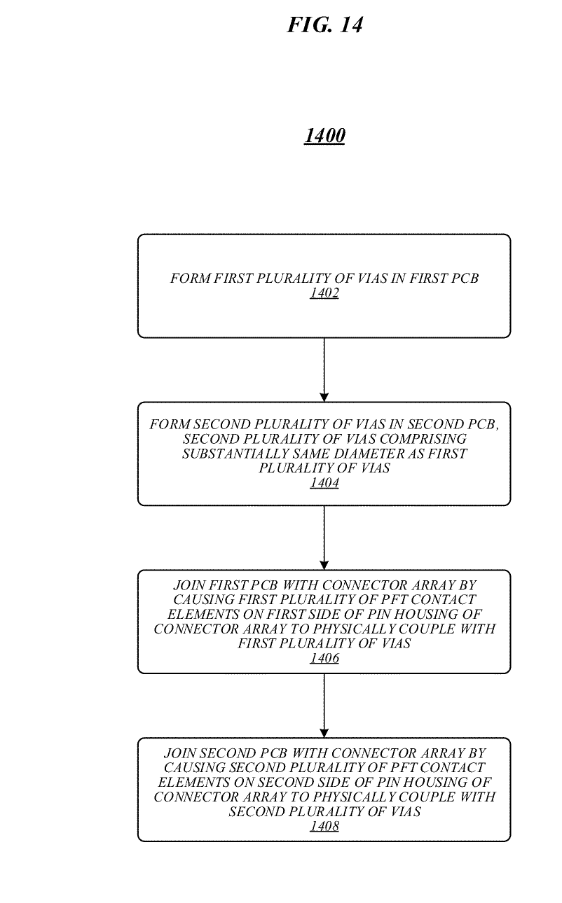

FIG. 14 illustrates an example of a logic flow 1400 that may be representative of the implementation of one or more of the disclosed techniques according to some embodiments. For example, logic flow 1400 may be representative of operations that may be performed in various embodiments in conjunction with constructing assembly 600 of FIG. 6. As shown in FIG. 14, a first plurality of vias may be formed in a first PCB at 1402. For example, vias 366-1, 366-2, and 366-3 may be formed in PCB 350 of FIGS. 3A to 6. At 1404, a second plurality of vias may be formed in a second PCB, and the second plurality of vias may comprise a substantially same diameter as the first plurality of vias formed in the first PCB. For example, vias 316-1, 316-2, and 316-3 may be formed in PCB 300 of FIGS. 3A to 6, and may comprise a substantially same diameter w as do vias 366-1, 366-2, and 366-3.

At 1406, the first PCB may be joined with a connector array by causing a first plurality of PFT contact elements on a first side of a pin housing of the connector array to physically couple with the first plurality of vias. For example, PCB 350 of FIGS. 3A to 6 may be joined with connector array 200 by causing contact elements 104-1, 104-2, and 104-3 on one side of housing 212 to physically couple with vias 366-1, 366-2, and 366-3 in PCB 350. At 1408, the second PCB may be joined with the connector array by causing a second plurality of PFT contact elements on a second side of the pin housing of the connector array to physically couple with the second plurality of vias. For example, on the opposite side of housing 212 as that of contact elements 104-1, 104-2, and 104-3, PCB 300 of FIGS. 3A to 6 may be joined with connector array 200 by causing contact elements 102-1, 102-2, and 102-3 to physically couple with vias 316-1, 316-2, and 316-3 in PCB 300. The embodiments are not limited to these examples.

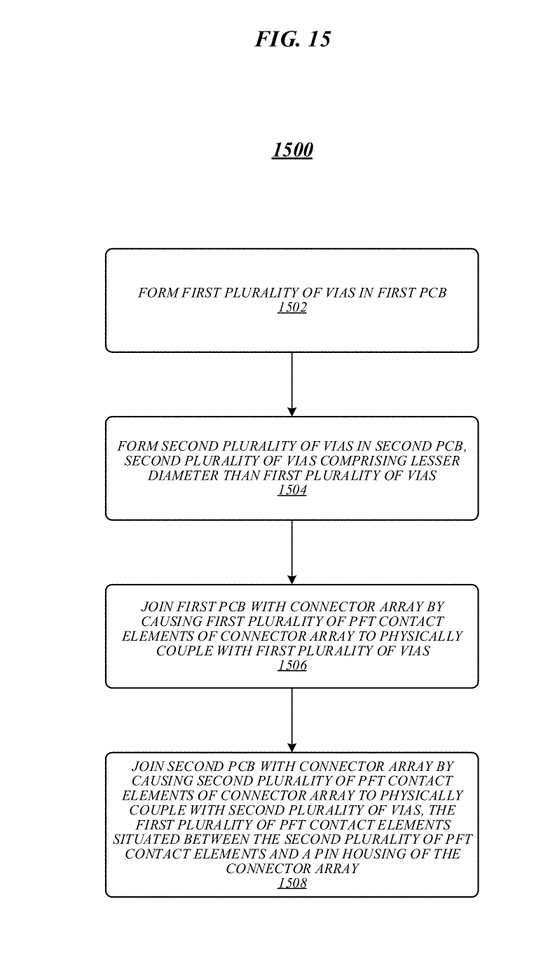

FIG. 15 illustrates an example of a logic flow 1500 that may be representative of the implementation of one or more of the disclosed techniques according to some embodiments. For example, logic flow 1500 may be representative of operations that may be performed in various embodiments in conjunction with constructing assembly 1200 of FIG. 12. As shown in FIG. 15, a first plurality of vias may be formed in a first PCB at 1502. For example, vias 916-1, 916-2, and 916-3 may be formed in PCB 900 of FIGS. 9A to 12. At 1504, a second plurality of vias may be formed in a second PCB, and the second plurality of vias may comprise a lesser diameter than does the first plurality of vias formed in the first PCB. For example, vias 966-1, 966-2, and 966-3 may be formed in PCB 950 of FIGS. 9A to 12, and may comprise a diameter w₂ that is smaller than a diameter w₁ comprised by vias 916-1, 916-2, and 916-3.

At 1506, the first PCB may be joined with a connector array by causing a first plurality of PFT contact elements of the connector array to physically couple with the first plurality of vias. For example, PCB 900 of FIGS. 9A to 12 may be joined with connector array 800 by causing contact elements 702-1, 702-2, and 702-3 to physically couple with vias 916-1, 916-2, and 916-3 in PCB 900. At 1508, the second PCB may be joined with the connector array by causing a second plurality of PFT contact elements of the connector array to physically couple with the second plurality of vias, where the first plurality of PFT contact elements is situated between the second plurality of PFT contact elements and a pin housing of the connector array. For example, PCB 950 of FIGS. 9A to 12 may be joined with connector array 800 by causing contact elements 704-1, 704-2, and 704-3 to physically couple with vias 966-1, 966-2, and 966-3 in PCB 950, and contact elements 702-1, 702-2, and 702-3 of connector array 800 may be situated between contact elements 704-1, 704-2, and 704-3 and housing 812. The embodiments are not limited to these examples.

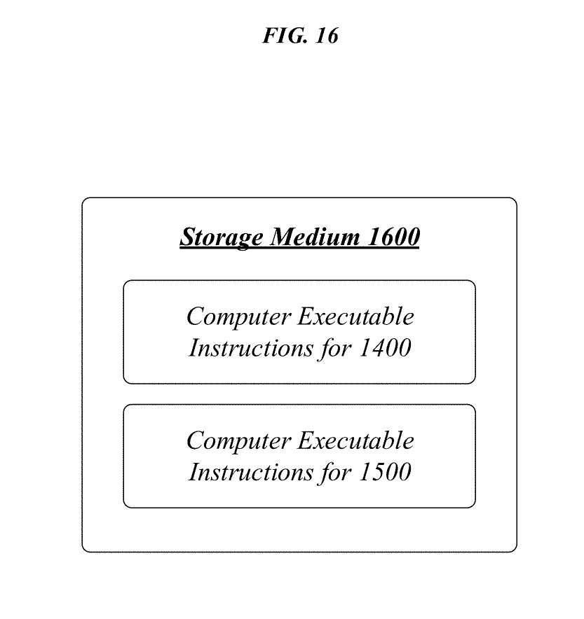

FIG. 16 illustrates an embodiment of a storage medium 1600. Storage medium 1600 may comprise any computer-readable storage medium or machine-readable storage medium, such as an optical, magnetic or semiconductor storage medium. In various embodiments, storage medium 1600 may comprise an article of manufacture. In some embodiments, storage medium 1600 may comprise a non-transitory storage medium. In some embodiments, storage medium 1600 may store computer-executable instructions, such as computer-executable instructions to implement one or both of logic flow 1400 of FIG. 14 and logic flow 1500 of FIG. 15. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

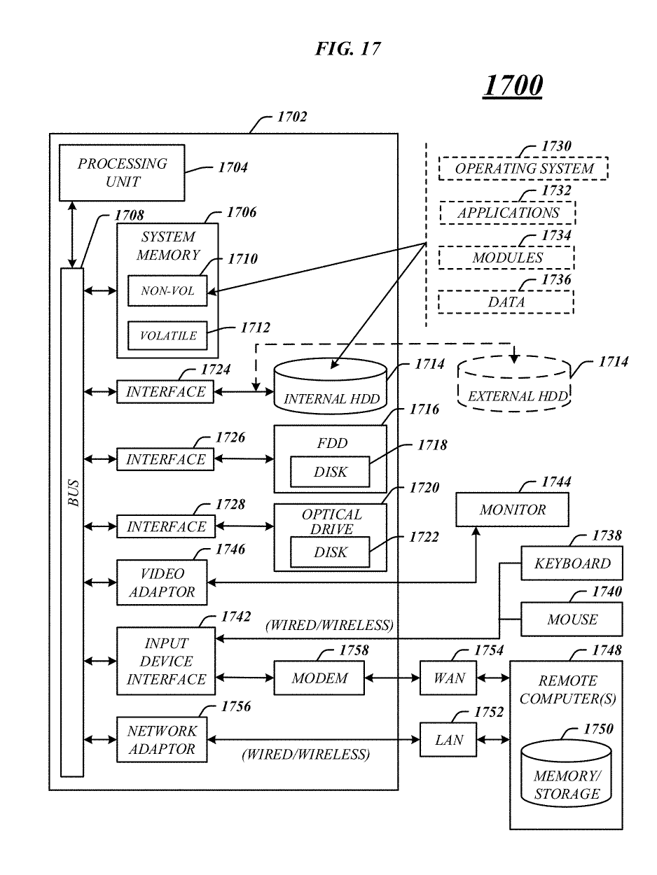

FIG. 17 illustrates an embodiment of an exemplary computing architecture 1700 that may be suitable for implementing various embodiments as previously described. In various embodiments, the computing architecture 1700 may comprise or be implemented as part of an electronic device. In some embodiments, the computing architecture 1700 may be representative, for example, of a computing device that comprises a structure featuring two PCBs attached using a connector array such as connector array 200 of FIG. 2A or connector array 800 of FIG. 8A. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 1700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1700.

As shown in FIG. 17, according to computing architecture 1700, a computer 1702 comprises a processing unit 1704, a system memory 1706 and a system bus 1708. In some embodiments, computer 1702 may comprise a server. In some embodiments, computer 1702 may comprise a client. The processing unit 1704 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1704.

The system bus 1708 provides an interface for system components including, but not limited to, the system memory 1706 to the processing unit 1704. The system bus 1708 can be any of several types of bus structure that may further interconnect to a memory bus (with or without a memory controller), a peripheral bus, and a local bus using any of a variety of commercially available bus architectures. Interface adapters may connect to the system bus 1708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 17, the system memory 1706 can include non-volatile memory 1710 and/or volatile memory 1712. A basic input/output system (BIOS) can be stored in the non-volatile memory 1710.

The computer 1702 may include various types of computer-readable storage media in the form of one or more lower speed memory units, including an internal (or external) hard disk drive (HDD) 1714, a magnetic floppy disk drive (FDD) 1716 to read from or write to a removable magnetic disk 1718, and an optical disk drive 1720 to read from or write to a removable optical disk 1722 (e.g., a CD-ROM or DVD). The HDD 1714, FDD 1716 and optical disk drive 1720 can be connected to the system bus 1708 by a HDD interface 1724, an FDD interface 1726 and an optical drive interface 1728, respectively. The HDD interface 1724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1710, 1712, including an operating system 1730, one or more application programs 1732, other program modules 1734, and program data 1736.

A user can enter commands and information into the computer 1702 through one or more wire/wireless input devices, for example, a keyboard 1738 and a pointing device, such as a mouse 1740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1704 through an input device interface 1742 that is coupled to the system bus 1708, but can be connected by other interfaces such as a parallel port, IEEE 1394 serial port, a game port, a USB port, an IR interface, and so forth.

A monitor 1744 or other type of display device is also connected to the system bus 1708 via an interface, such as a video adaptor 1746. The monitor 1744 may be internal or external to the computer 1702. In addition to the monitor 1744, a computer typically includes other peripheral output devices, such as speakers, printers, and so forth.

The computer 1702 may operate in a networked environment using logical connections via wire and/or wireless communications to one or more remote computers, such as a remote computer 1748. The remote computer 1748 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1750 is illustrated. The logical connections depicted include wire/wireless connectivity to a local area network (LAN) 1752 and/or larger networks, for example, a wide area network (WAN) 1754. Such LAN and WAN networking environments are commonplace in offices and companies, and facilitate enterprise-wide computer networks, such as intranets, all of which may connect to a global communications network, for example, the Internet.

When used in a LAN networking environment, the computer 1702 is connected to the LAN 1752 through a wire and/or wireless communication network interface or adaptor 1756. The adaptor 1756 can facilitate wire and/or wireless communications to the LAN 1752, which may also include a wireless access point disposed thereon for communicating with the wireless functionality of the adaptor 1756.

When used in a WAN networking environment, the computer 1702 can include a modem 1758, or is connected to a communications server on the WAN 1754, or has other means for establishing communications over the WAN 1754, such as by way of the Internet. The modem 1758, which can be internal or external and a wire and/or wireless device, connects to the system bus 1708 via the input device interface 1742. In a networked environment, program modules depicted relative to the computer 1702, or portions thereof, can be stored in the remote memory/storage device 1750. It will be appreciated that the network connections shown are exemplary and other means of establishing a communications link between the computers can be used.

The computer 1702 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

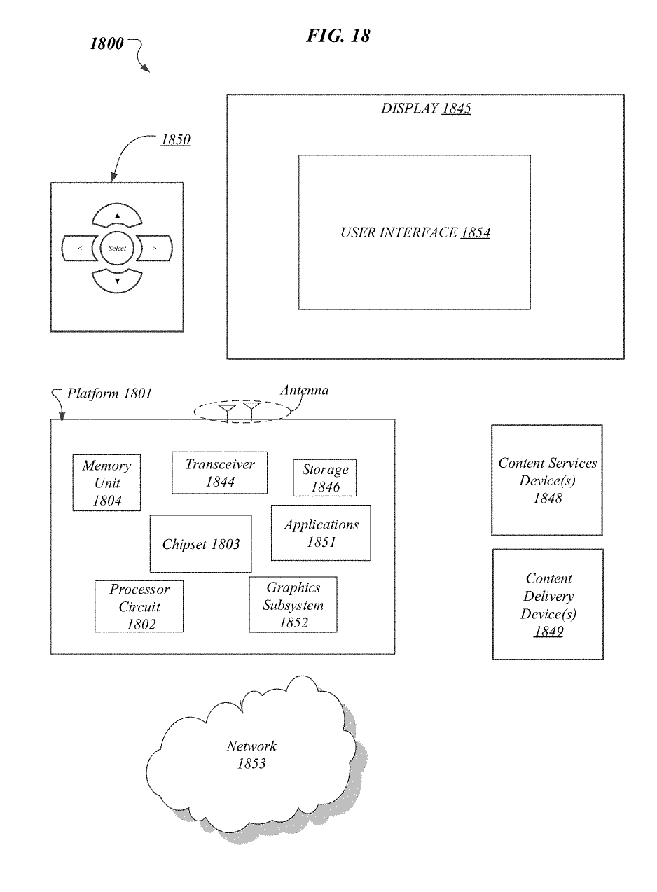

FIG. 18 illustrates an embodiment of a system 1800. In various embodiments, system 1800 may be representative of a system or architecture that is realized according to one or more techniques described herein, such as one or more of connector array 200 of FIG. 2A, assembly 600 of FIG. 6, connector array 800 of FIG. 8A, assembly 1200 of FIG. 12, assembly 1300 of FIG. 13, logic flow 1400 of FIG. 14, logic flow 1500 of FIG. 15, storage medium 1600 of FIG. 16, and computing architecture 1700 of FIG. 17. The embodiments are not limited in this respect.

As shown in FIG. 18, system 1800 may include multiple elements. One or more elements may be implemented using one or more circuits, components, registers, processors, software subroutines, modules, or any combination thereof, as desired for a given set of design or performance constraints. Although FIG. 18 shows a limited number of elements in a certain topology by way of example, it can be appreciated that more or less elements in any suitable topology may be used in system 1800 as desired for a given implementation. The embodiments are not limited in this context.

In embodiments, system 1800 may be a media system although system 1800 is not limited to this context. For example, system 1800 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 1800 includes a platform 1801 coupled to a display 1845. Platform 1801 may receive content from a content device such as content services device(s) 1848 or content delivery device(s) 1849 or other similar content sources. A navigation controller 1850 including one or more navigation features may be used to interact with, for example, platform 1801 and/or display 1845. Each of these components is described in more detail below.

In embodiments, platform 1801 may include any combination of a processor circuit 1802, chipset 1803, memory unit 1804, transceiver 1844, storage 1846, applications 1851, and/or graphics subsystem 1852. Chipset 1803 may provide intercommunication among processor circuit 1802, memory unit 1804, transceiver 1844, storage 1846, applications 1851, and/or graphics subsystem 1852. For example, chipset 1803 may include a storage adapter (not depicted) capable of providing intercommunication with storage 1846.

Processor circuit 1802 may be implemented using any processor or logic device, and may be the same as or similar to processing unit 1704 of FIG. 17. Memory unit 1804 may be implemented using any machine-readable or computer-readable media capable of storing data, and may be the same as or similar to system memory 1706 of FIG. 17. Transceiver 1844 may include one or more radios capable of transmitting and receiving signals using various suitable wireless communications techniques. Display 1845 may include any television type monitor or display, and may be the same as or similar to monitor 1744 of FIG. 17. Storage 1846 may be implemented as a non-volatile storage device, and may be the same as or similar to HDD 1714 of FIG. 17.

Graphics subsystem 1852 may perform processing of images such as still or video for display. Graphics subsystem 1852 may be a graphics processing unit (GPU) or a visual processing unit (VPU), for example. An analog or digital interface may be used to communicatively couple graphics subsystem 1852 and display 1845. For example, the interface may be any of a High-Definition Multimedia Interface, DisplayPort, wireless HDMI, and/or wireless HD compliant techniques. Graphics subsystem 1852 could be integrated into processor circuit 1802 or chipset 1803. Graphics subsystem 1852 could be a stand-alone card communicatively coupled to chipset 1803.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

In embodiments, content services device(s) 1848 may be hosted by any national, international and/or independent service and thus accessible to platform 1801 via the Internet, for example. Content services device(s) 1848 may be coupled to platform 1801 and/or to display 1845. Platform 1801 and/or content services device(s) 1848 may be coupled to a network 1853 to communicate (e.g., send and/or receive) media information to and from network 1853. Content delivery device(s) 1849 also may be coupled to platform 1801 and/or to display 1845.

In embodiments, content services device(s) 1848 may include a cable television box, personal computer, network, telephone, Internet enabled devices or appliance capable of delivering digital information and/or content, and any other similar device capable of unidirectionally or bidirectionally communicating content between content providers and platform 1801 and/display 1845, via network 1853 or directly. It will be appreciated that the content may be communicated unidirectionally and/or bidirectionally to and from any one of the components in system 1800 and a content provider via network 1853. Examples of content may include any media information including, for example, video, music, medical and gaming information, and so forth.

Content services device(s) 1848 receives content such as cable television programming including media information, digital information, and/or other content. Examples of content providers may include any cable or satellite television or radio or Internet content providers. The provided examples are not meant to limit embodiments of the disclosed subject matter.

In embodiments, platform 1801 may receive control signals from navigation controller 1850 having one or more navigation features. The navigation features of navigation controller 1850 may be used to interact with a user interface 1854, for example. In embodiments, navigation controller 1850 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 1850 may be echoed on a display (e.g., display 1845) by movements of a pointer, cursor, focus ring, or other visual indicators displayed on the display. For example, under the control of software applications 1851, the navigation features located on navigation controller 1850 may be mapped to virtual navigation features displayed on user interface 1854. In embodiments, navigation controller 1850 may not be a separate component but integrated into platform 1801 and/or display 1845. Embodiments, however, are not limited to the elements or in the context shown or described herein.

In embodiments, drivers (not shown) may include technology to enable users to instantly turn on and off platform 1801 like a television with the touch of a button after initial boot-up, when enabled, for example. Program logic may allow platform 1801 to stream content to media adaptors or other content services device(s) 1848 or content delivery device(s) 1849 when the platform is turned “off.” In addition, chip set 1803 may include hardware and/or software support for 5.1 surround sound audio and/or high definition 7.1 surround sound audio, for example. Drivers may include a graphics driver for integrated graphics platforms. In embodiments, the graphics driver may include a peripheral component interconnect (PCI) Express graphics card.

In various embodiments, any one or more of the components shown in system 1800 may be integrated. For example, platform 1801 and content services device(s) 1848 may be integrated, or platform 1801 and content delivery device(s) 1849 may be integrated, or platform 1801, content services device(s) 1848, and content delivery device(s) 1849 may be integrated, for example. In various embodiments, platform 1801 and display 1845 may be an integrated unit. Display 1845 and content service device(s) 1848 may be integrated, or display 1845 and content delivery device(s) 1849 may be integrated, for example. These examples are not meant to limit the disclosed subject matter.

In various embodiments, system 1800 may be implemented as a wireless system, a wired system, or a combination of both. When implemented as a wireless system, system 1800 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1800 may include components and interfaces suitable for communicating over wired communications media, such as I/O adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 1801 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 18.

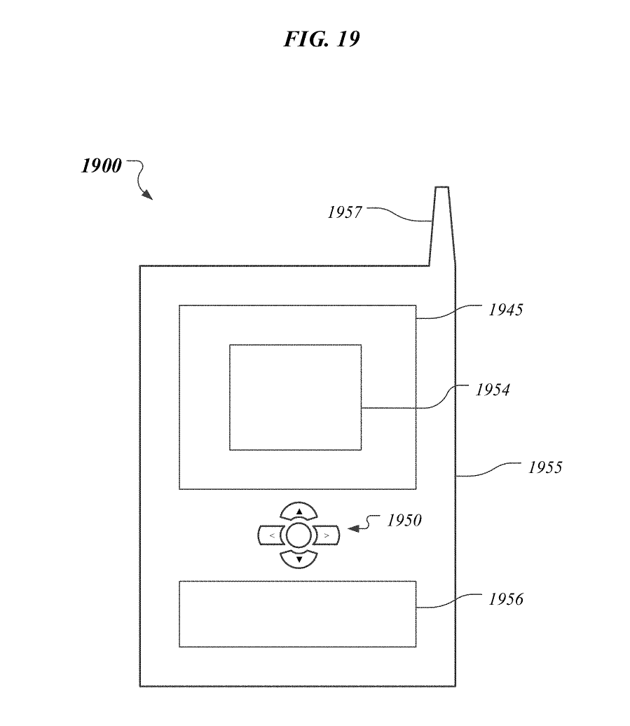

As described above, system 1800 may be embodied in varying physical styles or form factors. FIG. 19 illustrates embodiments of a small form factor device 1900 in which system 1800 may be embodied. In embodiments, for example, device 1900 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 19, device 1900 may include a display 1945, a navigation controller 1950, a user interface 1954, a housing 1955, an I/O device 1956, and an antenna 1957. Display 1945 may include any suitable display unit for displaying information appropriate for a mobile computing device, and may be the same as or similar to display 1845 in FIG. 18. Navigation controller 1950 may include one or more navigation features which may be used to interact with user interface 1954, and may be the same as or similar to navigation controller 1850 in FIG. 18. I/O device 1956 may include any suitable I/O device for entering information into a mobile computing device. Examples for I/O device 1956 may include an alphanumeric keyboard, a numeric keypad, a touch pad, input keys, buttons, switches, rocker switches, microphones, speakers, voice recognition device and software, and so forth. Information also may be entered into device 1900 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments:

Example 1 is an apparatus, comprising a first printed circuit board (PCB), a second PCB, and a connector array to attach the first PCB to the second PCB, the connector array comprising a plurality of press-fit (PFT) pins, each one of the plurality of PFT pins comprising a first PFT contact element physically coupled with a respective one of a plurality of vias of the first PCB and a second PFT contact element physically coupled with a respective one of a plurality of vias of the second PCB, at least one of the plurality of PFT pins to electrically couple a conductive element of the first PCB with a conductive element of the second PCB.

Example 2 is the apparatus of Example 1, the conductive element of the first PCB and the conductive element of the second PCB to comprise conductive traces.

Example 3 is the apparatus of any of Examples 1 to 2, the connector array to electrically couple each one of a plurality of conductive traces of the first PCB with a respective one of a plurality of conductive traces of the second PCB.

Example 4 is the apparatus of any of Examples 1 to 3, the first and second PCBs to include a main PCB and a patch PCB attached to the main PCB to relieve routing congestion in a region of the main PCB.

Example 5 is the apparatus of any of Examples 1 to 4, the connector array to include a pin housing to house a portion of each of the plurality of PFT pins.

Example 6 is the apparatus of Example 5, the pin housing to house a plurality of anchoring elements, each one of the plurality of anchoring elements to mechanically stabilize a respective one of the plurality of PFT pins.

Example 7 is the apparatus of Example 6, each one of the plurality of anchoring elements to comprise a portion of a same unitary structure as a respective one of the plurality of PFT pins.

Example 8 is the apparatus of any of Examples 5 to 7, the pin housing situated between the first PCB and the second PCB.

Example 9 is the apparatus of any of Examples 5 to 7, wherein the first PCB is situated between the pin housing and the second PCB, or the second PCB is situated between the pin housing and the first PCB.

Example 10 is the apparatus of any of Examples 1 to 9, the plurality of vias of the first PCB and the plurality of vias of the second PCB to comprise a substantially same diameter.

Example 11 is the apparatus of any of Examples 1 to 9, the plurality of vias of the first PCB to comprise a diameter that substantially differs from a diameter of the plurality of vias of the second PCB.

Example 12 is the apparatus of any of Examples 1 to 11, comprising one or more supplemental fasteners to align the first PCB and the second PCB.

Example 13 is the apparatus of any of Examples 1 to 12, each of the plurality of PFT pins comprising a double-PFT pin.

Example 14 is the apparatus of any of Examples 1 to 13, the first and second PFT contact elements comprising PFT rings.

Example 15 is the apparatus of any of Examples 1 to 14, the first and second PFT contact elements to exert outward force upon inner surfaces of the vias of the first and second PCBs while compressed within the vias of the first and second PCBs.

Example 16 is a system, comprising an apparatus according to any of Examples 1 to 15, and at least one processor circuit.

Example 17 is the system of Example 16, the first and second PCBs to include a main PCB and a patch PCB attached to the main PCB, the at least one processor circuit comprised on the patch PCB.

Example 18 is the system of any of Examples 16 to 17, comprising at least one radio frequency (RF) transceiver, and at least one RF antenna.

Example 19 is the system of any of Examples 16 to 18, comprising a touchscreen display.

Example 20 is a method, comprising attaching a first PCB to a second PCB using a connector array comprising a plurality of press-fit (PFT) pins, each one of the plurality of PFT pins comprising a first PFT contact element to physically couple with a respective one of a plurality of vias of the first PCB and a second PFT contact element to physically couple with a respective one of a plurality of vias of the second PCB, at least one of the plurality of PFT pins to electrically couple a conductive element of the first PCB with a conductive element of the second PCB.

Example 21 is the method of Example 20, comprising forming the plurality of vias of the first PCB.

Example 22 is the method of any of Examples 20 to 21, comprising forming the plurality of vias of the second PCB.

Example 23 is the method of any of Examples 20 to 22, the conductive element of the first PCB and the conductive element of the second PCB to comprise conductive traces.

Example 24 is the method of any of Examples 20 to 23, the connector array to electrically couple each one of a plurality of conductive traces of the first PCB with a respective one of a plurality of conductive traces of the second PCB.

Example 25 is the method of any of Examples 20 to 24, comprising attaching the first PCB to the second PCB to relieve routing congestion in a region of the second PCB.

Example 26 is the method of any of Examples 20 to 25, the connector array to include a pin housing to house a portion of each of the plurality of PFT pins.

Example 27 is the method of Example 26, the pin housing to house a plurality of anchoring elements, each one of the plurality of anchoring elements to mechanically stabilize a respective one of the plurality of PFT pins.

Example 28 is the method of Example 27, each one of the plurality of anchoring elements to comprise a portion of a same unitary structure as a respective one of the plurality of PFT pins.

Example 29 is the method of any of Examples 26 to 28, the pin housing situated between the first PCB and the second PCB.

Example 30 is the method of any of Examples 26 to 28, wherein the first PCB is situated between the pin housing and the second PCB, or the second PCB is situated between the pin housing and the first PCB.

Example 31 is the method of any of Examples 20 to 30, the plurality of vias of the first PCB and the plurality of vias of the second PCB to comprise a substantially same diameter.

Example 32 is the method of any of Examples 20 to 30, the plurality of vias of the first PCB to comprise a diameter that substantially differs from a diameter of the plurality of vias of the second PCB.

Example 33 is the method of any of Examples 20 to 32, comprising aligning the first PCB and the second PCB using one or more supplemental fasteners.

Example 34 is the method of any of Examples 20 to 33, each of the plurality of PFT pins comprising a double-PFT pin.

Example 35 is the method of any of Examples 20 to 34, the first and second PFT contact elements comprising PFT rings.

Example 36 is the method of any of Examples 20 to 35, the first and second PFT contact elements to exert outward force upon inner surfaces of the vias of the first and second PCBs while compressed within the vias of the first and second PCBs.

Example 37 is at least one machine-readable storage medium comprising a set of instructions that, in response to being executed by circuitry of a device, cause the device to perform a method according to any of Examples 20 to 36.

Example 38 is an apparatus, comprising means for performing a method according to any of Examples 20 to 36.

Example 39 is at least one machine-readable storage medium comprising a set of instructions that, in response to being executed by circuitry of a device, cause the device to attach a first PCB to a second PCB using a connector array comprising a plurality of press-fit (PFT) pins, each one of the plurality of PFT pins to comprise a first PFT contact element to physically couple with a respective one of a plurality of vias of the first PCB and a second PFT contact element to physically couple with a respective one of a plurality of vias of the second PCB, at least one of the plurality of PFT pins to electrically couple a conductive element of the first PCB with a conductive element of the second PCB.

Example 40 is the at least one machine-readable storage medium of Example 39, comprising instructions that, in response to being executed by circuitry of the device, cause the device to form the plurality of vias of the first PCB.

Example 41 is the at least one machine-readable storage medium of any of Examples 39 to 40, comprising instructions that, in response to being executed by circuitry of the device, cause the device to form the plurality of vias of the second PCB.

Example 42 is the at least one machine-readable storage medium of any of Examples 39 to 41, the conductive element of the first PCB and the conductive element of the second PCB to comprise conductive traces.

Example 43 is the at least one machine-readable storage medium of any of Examples 39 to 42, the connector array to electrically couple each one of a plurality of conductive traces of the first PCB with a respective one of a plurality of conductive traces of the second PCB.

Example 44 is the at least one machine-readable storage medium of any of Examples 39 to 43, comprising instructions that, in response to being executed by circuitry of the device, cause the device to attach the first PCB to the second PCB to relieve routing congestion in a region of the second PCB.

Example 45 is the at least one machine-readable storage medium of any of Examples 39 to 44, the connector array to include a pin housing to house a portion of each of the plurality of PFT pins.

Example 46 is the at least one machine-readable storage medium of Example 45, the pin housing to house a plurality of anchoring elements, each one of the plurality of anchoring elements to mechanically stabilize a respective one of the plurality of PFT pins.

Example 47 is the at least one machine-readable storage medium of Example 46, each one of the plurality of anchoring elements to comprise a portion of a same unitary structure as a respective one of the plurality of PFT pins.

Example 48 is the at least one machine-readable storage medium of any of Examples 45 to 47, the pin housing to be situated between the first PCB and the second PCB.

Example 49 is the at least one machine-readable storage medium of any of Examples 45 to 47, wherein the first PCB is to be situated between the pin housing and the second PCB, or the second PCB is to be situated between the pin housing and the first PCB.

Example 50 is the at least one machine-readable storage medium of any of Examples 39 to 49, the plurality of vias of the first PCB and the plurality of vias of the second PCB to comprise a substantially same diameter.

Example 51 is the at least one machine-readable storage medium of any of Examples 39 to 49, the plurality of vias of the first PCB to comprise a diameter that substantially differs from a diameter of the plurality of vias of the second PCB.

Example 52 is the at least one machine-readable storage medium of any of Examples 39 to 51, comprising instructions that, in response to being executed by circuitry of the device, cause the device to align the first PCB and the second PCB using one or more supplemental fasteners.

Example 53 is the at least one machine-readable storage medium of any of Examples 39 to 52, each of the plurality of PFT pins to comprise a double-PFT pin.

Example 54 is the at least one machine-readable storage medium of any of Examples 39 to 53, the first and second PFT contact elements to comprise PFT rings.

Example 55 is the at least one machine-readable storage medium of any of Examples 39 to 54, the first and second PFT contact elements to exert outward force upon inner surfaces of the vias of the first and second PCBs while compressed within the vias of the first and second PCBs.

Example 56 is an apparatus, comprising means for attaching a first PCB to a second PCB using a connector array comprising a plurality of press-fit (PFT) pins, each one of the plurality of PFT pins to comprise a first PFT contact element to physically couple with a respective one of a plurality of vias of the first PCB and a second PFT contact element to physically couple with a respective one of a plurality of vias of the second PCB, at least one of the plurality of PFT pins to electrically couple a conductive element of the first PCB with a conductive element of the second PCB.

Example 57 is the apparatus of Example 56, comprising means for forming the plurality of vias of the first PCB.

Example 58 is the apparatus of any of Examples 56 to 57, comprising means for forming the plurality of vias of the second PCB.

Example 59 is the apparatus of any of Examples 56 to 58, the conductive element of the first PCB and the conductive element of the second PCB to comprise conductive traces.

Example 60 is the apparatus of any of Examples 56 to 59, the connector array to electrically couple each one of a plurality of conductive traces of the first PCB with a respective one of a plurality of conductive traces of the second PCB.

Example 61 is the apparatus of any of Examples 56 to 60, comprising means for attaching the first PCB to the second PCB to relieve routing congestion in a region of the second PCB.

Example 62 is the apparatus of any of Examples 56 to 61, the connector array to include a pin housing to house a portion of each of the plurality of PFT pins.

Example 63 is the apparatus of Example 62, the pin housing to house a plurality of anchoring elements, each one of the plurality of anchoring elements to mechanically stabilize a respective one of the plurality of PFT pins.

Example 64 is the apparatus of Example 63, each one of the plurality of anchoring elements to comprise a portion of a same unitary structure as a respective one of the plurality of PFT pins.

Example 65 is the apparatus of any of Examples 62 to 64, the pin housing to be situated between the first PCB and the second PCB.

Example 66 is the apparatus of any of Examples 62 to 64, wherein the first PCB is to be situated between the pin housing and the second PCB, or the second PCB is to be situated between the pin housing and the first PCB.

Example 67 is the apparatus of any of Examples 56 to 66, the plurality of vias of the first PCB and the plurality of vias of the second PCB to comprise a substantially same diameter.

Example 68 is the apparatus of any of Examples 56 to 66, the plurality of vias of the first PCB to comprise a diameter that substantially differs from a diameter of the plurality of vias of the second PCB.

Example 69 is the apparatus of any of Examples 56 to 68, comprising means for aligning the first PCB and the second PCB using one or more supplemental fasteners.

Example 70 is the apparatus of any of Examples 56 to 69, each of the plurality of PFT pins to comprise a double-PFT pin.

Example 71 is the apparatus of any of Examples 56 to 70, the first and second PFT contact elements to comprise PFT rings.

Example 72 is the apparatus of any of Examples 56 to 71, the first and second PFT contact elements to exert outward force upon inner surfaces of the vias of the first and second PCBs while compressed within the vias of the first and second PCBs.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a first printed circuit board (PCB);
a second PCB; and
a connector array to attach the first PCB to the second PCB, the connector array comprising:
a plurality of press-fit (PFT) pins, each one of the plurality of PFT pins comprising a first PFT contact element physically coupled with a respective one of a plurality of vias of the first PCB and a second PFT contact element physically coupled with a respective one of a plurality of vias of the second PCB, at least one of the plurality of PFT pins to electrically couple a conductive element of the first PCB with a conductive element of the second PCB;
a pin housing to house a portion of each of the plurality of PFT pins; and
a plurality of anchoring elements, each one of the plurality of anchoring elements to mechanically stabilize a respective one of the plurality of PFT pins.

2. The apparatus of claim 1, the conductive element of the first PCB and the conductive element of the second PCB to comprise conductive traces.

3. The apparatus of claim 1, the connector array to electrically couple each one of a plurality of conductive traces of the first PCB with a respective one of a plurality of conductive traces of the second PCB.

4. The apparatus of claim 1, the first PCB comprising a main PCB and the second PCB comprising a patch PCB to relieve routing congestion in a region of the main PCB.

5-6. (canceled)

7. The apparatus of claim 1, each one of the plurality of anchoring elements to comprise a portion of a same unitary structure as a respective one of the plurality of PFT pins.

8. The apparatus of claim 1, the pin housing situated between the first PCB and the second PCB.

9. The apparatus of claim 1, wherein:
the first PCB is situated between the pin housing and the second PCB; or
the second PCB is situated between the pin housing and the first PCB.

10. The apparatus of claim 1, the plurality of vias of the first PCB and the plurality of vias of the second PCB to comprise a substantially same diameter.

11. The apparatus of claim 1, the plurality of vias of the first PCB to comprise a diameter that substantially differs from a diameter of the plurality of vias of the second PCB.

12. The apparatus of claim 1, comprising one or more supplemental fasteners to align the first PCB and the second PCB.

13. The apparatus of claim 1, each of the plurality of PFT pins comprising a double-PFT pin.

14. The apparatus of claim 1, the first and second PFT contact elements comprising PFT rings.

15. The apparatus of claim 1, the first and second PFT contact elements to exert outward force upon inner surfaces of the vias of the first and second PCBs while compressed within the vias of the first and second PCBs.

16. A system, comprising:
a first printed circuit board (PCB);
at least one processor circuit electrically coupled to a conductive element of the first PCB;
a second PCB; and
a connector array to attach the first PCB to the second PCB, the connector array comprising:
a plurality of press-fit (PFT) pins, each one of the plurality of PFT pins comprising a first PFT contact element physically coupled with a respective one of a plurality of vias of the first PCB and a second PFT contact element physically coupled with a respective one of a plurality of vias of the second PCB, at least one of the plurality of PFT pins to electrically couple the conductive element of the first PCB with a conductive element of the second PCB;
a pin housing to house a portion of each of the plurality of PFT pins; and
a plurality of anchoring elements, each one of the plurality of anchoring elements to mechanically stabilize a respective one of the plurality of PFT pins.

17. The system of claim 16, the first and second PCBs to include a main PCB and a patch PCB attached to the main PCB, the at least one processor circuit comprised on the patch PCB.

18. An apparatus, comprising:
means for attaching a first PCB to a second PCB using a connector array comprising a plurality of press-fit (PFT) pins, each one of the plurality of PFT pins comprising a first PFT contact element to physically couple with a respective one of a plurality of vias of the first PCB and a second PFT contact element to physically couple with a respective one of a plurality of vias of the second PCB, at least one of the plurality of PFT pins to electrically couple a conductive element of the first PCB with a conductive element of the second PCB; the connector array to include a pin housing to house a plurality of anchoring elements, each one of the plurality of anchoring elements to mechanically stabilize a respective one of the plurality of PFT pins.

19. The apparatus of claim 18, the connector array to electrically couple each one of a plurality of conductive traces of the first PCB with a respective one of a plurality of conductive traces of the second PCB.

20. The apparatus of claim 18, comprising means for attaching the first PCB to the second PCB to relieve routing congestion in a region of the first PCB.

21. (canceled)

22. The apparatus of claim 18, the pin housing situated between the first PCB and the second PCB.

23. The apparatus of claim 18, wherein:
the first PCB is situated between the pin housing and the second PCB; or
the second PCB is situated between the pin housing and the first PCB.

24. The apparatus of claim 18, the plurality of vias of the first PCB and the plurality of vias of the second PCB to comprise a substantially same diameter.

25. The apparatus of claim 18, the plurality of vias of the first PCB to comprise a diameter that substantially differs from a diameter of the plurality of vias of the second PCB.
